(19) United States
(12) Patent Application Publication
(10) Pub. No.: US 2004/0053149 A1
(43) Pub. Date: Mar. 18, 2004

(54) Electrophotographic photoreceptor, method for manufacturing the electrophotographic photoreceptor, and image forming apparatus using the electrophotographic photoreceptor

(76) Inventors: Naohiro Toda, Yokohama-shi (JP); Tatsuya Niimi, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/606,750

(22) Filed: Jun. 27, 2003

(30) Foreign Application Priority Data
Jun. 28, 2002 (JP) 2002-191290
Oct. 22, 2002 (JP) 2002-306757
Mar. 20, 2003 (JP) 2003-078695

(51) Int. Cl. G03G 5/047

(52) U.S. Cl. 430/58.7; 430/59.5; 430/59.1; 430/96; 430/134; 430/66; 399/159

(57) ABSTRACT

A photoreceptor including an electroconductive substrate; a charge generation layer located overlying the electroconductive substrate optionally with an intermediate layer therebetween; and a charge transport layer formed overlying the charge generation layer using a non-halogenated solvent and including a charge transport material and a resin, wherein the charge generation layer includes a polyvinyl acetal resin and a charge generation material having an average particle diameter less than a roughness of a surface of either the electroconductive substrate or the intermediate layer, on which the charge generation layer is located.

### BACKGROUND OF THE INVENTION

1. Field of the Invention

The present invention relates to an electrophotographic photoreceptor. In addition, the present invention also relates to a method for manufacturing the electrophotographic photoreceptor and an image forming apparatus using the electrophotographic photoreceptor.

2. Discussion of the Background

Recently development of information processing systems utilizing electrophotography is remarkable. In particular, optical printers which record information using light after information is converted to digital signals have been dramatically improved in print qualities and reliability. This digital recording technique is applied to not only printers but also copiers, and so-called digital copiers have been developed. Copiers utilizing both the conventional analogue recording technique and this digital recording technique have various information processing functions, and therefore it is expected that demand for such copiers will be escalating. In addition, with popularization and improvement of personal computers, the performance of digital color printers which can produce documents including color images has been rapidly improved.

Inorganic photosensitive materials such as Se, CdS and ZnO have been used as photosensitive materials for electrophotographic photoreceptors for use in such image forming apparatus. However, in recent years organic photosensitive materials are mainly used for the electrophotographic photoreceptors because of having advantages in optical sensitivity, thermal stability and toxicity. Among the electrophotographic photoreceptors including an organic photosensitive material, functionally-separated photoreceptors having a constitution such that a charge generation layer and a charge transport layer are overlaid are typically used now because of having good optical sensitivity and durability.

Various azo pigments, polycyclic quinone-based pigments, trigonal selenium and phthalocyanine pigments have been developed as charge generation materials for use in the charge generation layer. Among the charge generation materials, phthalocyanine pigments are very useful as a charge generation material because of having a high sensitivity against light having a relatively long wavelength of from 600 to 800 nm, which is used as image forming light in electrophotographic printers and digital copiers using a LED (light emitting diode) or LD laser diode) as a light source.

The charge transport layer includes a charge transport material and a binder resin as main components. The charge transport layer is typically prepared by coating a coating liquid which is prepared by dissolving or dispersing the materials in a proper solvent. As the solvent of the coating liquid, halogen-containing solvents such as dichloromethane and chloroform are typically used because of having good dissolving ability and coating property.

In recent years, ecological issues have been considered to be important, and therefore a need exists for photoreceptors which are prepared without using such halogen-containing solvents. However, when photoreceptors are repeatedly prepared using a solvent including no halogen atom (hereinafter referred to as a non-halogenated solvent), a problem in that the initial photosensitivity thereof is low or the photosensitivity thereof deteriorates when the photoreceptor is repeatedly used occurs although the resultant photoreceptor has good charging properties.

In attempting to prevent deterioration of photosensitivity, a technique such that a phthalocyanine pigment is subjected to a milling treatment to decrease the particle diameter of the pigment has been disclosed in, for example, published Japanese Patent Application No. 4-318557 and Journal of Imaging Science vol. 35, No. 4, p235, 1991.

In addition, published Japanese Patent Application No. 2001-115054 discloses a titanyl phthalocyanine in which a chlorinated titanyl phthalocyanine is included in non-substituted titanyl phthalocyanine in a specific amount, and a titanyl phthalocyanine pigment having a particle diameter not greater than 1 μm is used.

By using the technique and the materials, the resultant photoreceptors have good optical sensitivity when a halogen-containing solvent as a coating solvent. However, when a non-halogenated solvent is used, problems which occur are that the resultant photoreceptor has poor initial optical sensitivity, or even if the photoreceptor has good initial, optical sensitivity, the sensitivity seriously deteriorates when the photoreceptor is repeatedly used.

On the other hand, various methods have been proposed for forming a photoreceptor without using a halogen-containing solvent. For example, published unexamined Japanese Patent Application No. 10-326023 discloses a technique in that a dioxolan compound is used as a coating solvent. In addition, published unexamined Japanese Patent Application No. 2001-356506 discloses a technique such that a polycyclic ether compound is used as a coating liquid while using a stabilizer such as antioxidants and ultraviolet absorbents, which is added to prevent the polycyclic ether compound from generating peroxides.

However, these techniques have drawbacks such that the sensitivity improving effect is not satisfactory or the optical sensitivity of the resultant photoreceptor is undesirably deteriorated.

Because of these reasons, a need exists for an electrophotographic photoreceptor which can be prepared without using a halogen-containing solvent and which has good photosensitivity even when repeatedly used for a long period of time.

### SUMMARY OF THE INVENTION

Accordingly, an object of the present invention is to provide a photoreceptor which has good photosensitivity and charging ability even when repeatedly used for a long period of time and which has a charge transport layer formed without using a halogen-containing solvent.

Another object of the present invention is to provide a method for manufacturing the photoreceptor.

Yet another object of the present invention is to provide an image forming apparatus and a process cartridge which use the photoreceptor of the present invention and which can produce good images even when repeatedly used for a long period of time.

Briefly these objects and other objects of the present invention as hereinafter will become more readily apparent can be attained by a photoreceptor which includes an electroconductive substrate, a charge generation layer located overlying the electroconductive substrate optionally with an intermediate layer therebetween, and a charge transport layer which is formed overlying the charge generation layer using a non-halogenated solvent and which includes a charge transport material and a resin, wherein the charge generation layer includes a polyvinyl acetal resin and a charge generation material having an average particle diameter less than a roughness of a surface of either the electroconductive substrate or the intermediate layer, on which the charge generation layer is located.

The average particle diameter of the charge generation material is preferably not greater than 0.3 μm and not greater than ⅔ of the roughness of the surface of either the electroconductive substrate or the intermediate layer, on which the charge generation layer is located.

The charge generation material is preferably a titanyl phthalocyanine.

The titanyl phthalocyanine preferably has an X-ray diffraction spectrum in which a maximum peak is observed at a Bragg (2θ) angle of 27.2°±0.20° when a Cu—Kα X-ray having a wavelength of 1.542 Å is used.

It is preferable that the titanyl phthalocyanine further has a lowest angle peak at an angle of 7.3°±0.20° and has no peak at an angle of from 7.4° to 9.4° (i.e., an interval between the lowest angle peak to a next peak at a high angle side is not less than 2.0°). In addition, the titanyl phthalocyanine preferably has no peak at an angle of 26.3°.

The charge generation layer is preferably formed by using a dispersion which is prepared by dispersing the above-mentioned titanyl phthalocyanine so as to have particle diameter distribution such that the average particle diameter is not greater than 0.3 μm and the standard deviation is not greater than 0.2 μm and then filtering the resultant liquid with a filter having an effective pore size not greater than 3 μm.

The titanyl phthalocyanine for use in the charge generation layer is preferably prepared by subjecting a titanyl phthalocyanine which has an irregular form or a low crystallinity and has a primary particle diameter not greater than 0.1 μm and which has an X-ray diffraction spectrum in which a maximum peak having a half width not less than 1° is observed at a Bragg (2θ) angle of 7.0° to 7.5° (±0.2°) when a Cu—K α X-ray having a wavelength of 1.542 Å is used, to crystal conversion using an organic solvent in the presence of water, and then subjecting the crystal-changed titanyl phthalocyanine to filtering before the crystal-changed titanyl phthalocyanine has an average primary particle diameter not less than 0.3 μm.

It is preferable that the charge transport layer further includes a polycarbonate resin having at least a triaryl amine structure in its main chain and/or a side chain.

In addition, a protective layer serving as an outermost layer is preferably formed overlying the charge transport layer.

The protective layer preferably includes an inorganic pigment, such as metal oxides, having a resistivity not less than 1×10¹⁰ Ω·cm. The inorganic pigment is preferably one of alumina, titanium oxide and silica, and more preferably α-alumina.

The protective layer preferably includes a charge transport polymer.

The surface of the electroconductive substrate is preferably anodized.

The non-halogenated solvent is preferably a solvent selected from the group consisting of cyclic ethers and aromatic hydrocarbons.

Another aspect of the present invention, an image forming apparatus is provided which includes at least one image forming unit including:

an image bearing member;

a charger configured to charge the image bearing member;

a light irradiator configured to irradiate the image bearing member with light to form an electrostatic latent image;

an image developer configured to develop the electrostatic latent image with a developer to form a toner image on the image bearing member; and

a transfer device configured to transfer the toner image onto a receiving material,

wherein the image bearing member is the photoreceptor of the present invention.

The image forming apparatus may include plural image forming units.

The light irradiator preferably includes a light emitting diode or a laser diode.

The charger is preferably a contact charger, or a proximity charger which charges the image bearing member while being located closely to the image bearing member. When a proximity charger is used, the gap between the charger and the image bearing member is not greater than 200 μm. The charger preferably applies a DC voltage overlapped with an AC voltage.

As yet another aspect of the present invention, a process cartridge is provided which includes the photoreceptor of the present invention and at least one of a charger, a light irradiator, an image developer, a transfer device, and a cleaner.

As a further aspect of the present invention, a method for manufacturing a photoreceptor is provided which includes:

preparing a charge generation layer coating liquid including a dispersion of a titanyl phthalocyanine having a particle diameter distribution such that an average particle diameter is not greater than 0.3 μm and a standard deviation is not greater than 0.2 μm and a polyvinyl acetal;

filtering the charge generation layer coating liquid with a filter having an effective pore size not greater than 3 μm;

coating the charge generation layer coating liquid overlying an electroconductive substrate optionally with an intermediate layer therebetween; and

coating a charge transport layer coating liquid including a charge transport material, a resin and a non-halogenated solvent on the charge generation layer,

wherein the charge generation material in the charge generation layer has an average particle diameter less than a roughness of a surface of either the electroconductive substrate or the intermediate layer, on which the charge generation layer is located.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a photograph of a charge generation layer formed on a smooth surface of a substrate;

FIG. 2 is a photograph showing the surface of the charge generation layer illustrated in FIG. 1 after a halogen-containing solvent is applied on the surface of the charge generation layer;

FIG. 3 is a photograph showing the surface of the charge generation layer illustrated in FIG. 1 after a non-halogenated solvent is applied on the surface of the charge generation layer;

FIG. 4 is a photograph showing the surface of the charge generation layer formed on a rough surface after a halogen-containing solvent is applied on the surface of the charge generation layer;

FIG. 5 is a photograph showing the surface of the charge generation layer formed on a rough surface after a non-halogenated solvent is applied on the surface of the charge generation layer;

FIG. 6 is a schematic view illustrating the cross section of an embodiment of the photoreceptor of the present invention;

FIG. 7 is a schematic view illustrating the cross section of another embodiment of the photoreceptor of the present invention;

FIG. 8 is a schematic view illustrating the cross section of yet another embodiment of the photoreceptor of the present invention;

FIG. 9 is a schematic view illustrating a main part of the image forming apparatus of the present invention;

FIG. 10 is a schematic view illustrating a proximity charger for use in the image forming apparatus of the present invention;

FIG. 11 is a schematic view illustrating a main part of the image forming apparatus of the present invention, which has plural image forming units;

FIG. 12 is a schematic view illustrating an embodiment of the process cartridge of the present invention;

FIG. 13 is an X-ray diffraction spectrum of the titanyl phthalocyanine powder synthesized in Synthesis Example 1;

FIG. 14 is an X-ray diffraction spectrum of the titanyl phthalocyanine crystal synthesized in Synthesis Example 8;

FIG. 15 is an X-ray diffraction spectrum of the pigment prepared in Measurement Example 1; and

FIG. 16 is an X-ray diffraction spectrum of the pigment prepared in Measurement Example 2.

### DETAILED DESCRIPTION OF THE INVENTION

Specific examples of the non-halogenated solvents for use in the charge transport layer of the photoreceptor of the present invention include cyclohexanone, tetrahydrofuran, dioxolan, dioxane, toluene, xylene, ethyl ether, acetone, ethanol, methyl ethyl ketone, dimethylformamide, ethylene glycol, dimethyl ether, anisole, and the like solvents. Among these solvents, cyclic ethers such as tetrahydrofuran, dioxolan and dioxane, aromatic hydrocarbons such as toluene and xylene, and derivatives thereof are preferable.

In the present application, the roughness means the ten point mean roughness which can be measured by a method based on JIS B0601. Specifically, the roughness is represented by the difference between the average height of the five projected portions and the average depth of the five recessed portions in a unit length. The ten-point mean roughness can be measured using a surface roughness measuring instrument, SURFCOM 1400A manufactured by Tokyo Seimitsu Co., Ltd.

Suitable charge generation materials for use in the charge generation layer include azo pigments having a skeleton such as carbazole skeletons, triphenyl amine skeletons, diphenyl amine skeletons, dibenzo thiophene skeletons, fluorenone skeletons, oxadiazole skeletons, bisstilbene skeletons, distyryloxadiazole skeletons, and distyrylcarbazole skeletons; phthalocyanine pigments such as metal phthalocyanine and metal-free phthalocyanine; azulenium salt type pigments, squaric acid methyne pigments, perylene pigments, anthraquinone pigments, polycyclic quinone pigments, quinone imine pigments, diphenylmethane pigments, triphenylmethane pigments, benzoquinone pigments, naphthoquinone pigments, cyanine pigments, azomethyne pigments, indigoide pigments, benzimidazole pigments, and the like organic pigments. These organic pigments are used alone or in combination.

Among these pigments, titanyl phthalocyanine (hereinafter referred to as TiOPc) which is one of phthalocyanine pigments and which includes titanium as the center metal thereof is more preferable because of having a high sensitivity. The formula of TiOPc is as follows:

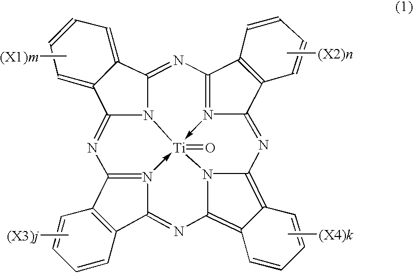

wherein X1, X2, X3 and X4 independently represent a halogen atom, and m, n, j and k are independently 0 or an integer of from 1 to 4.

The synthesis method and electrophotographic characteristics of TiOPc have been disclosed in various documents such as unexamined Japanese Patent Applications Nos. (herein after referred to as JOPs) 57-148745, 59-36254, 59-44054, 59-31965, 61-239248and62-67094. In addition, it is well known that TiOPc can have various crystal forms, as disclosed in JOPs 59-49544, 59-166959, 61-239248, 62-67094, 63-366, 63-116158, 63-196067, 64-17066 and 2001-19871.

Among these TiOPcs, a TiOPc having an X-ray diffraction spectrum in which a maximum diffraction peak is observed at a Bragg (2θ) angle of 27.2° is particularly preferable because of having excellent photosensitivity. In particular, when a TiOPc which is disclosed in JOP 2001-19871 and which has a maximum diffraction peak at an angle of 27.20 and a lowest angle peak at an angle of 7.3° while having no peak in a range of from 7.4° to 9.4° is used, the resultant photoreceptor can maintain good charging properties while having a high photosensitivity even when repeatedly used. Further, when the TiOPc has no peak at an angle of 26.3°, the effects are further enhanced.

JOP 6-293769 discloses a method for synthesizing a crude TiOPc, which does not use halogenated titanium. The advantage of the synthesis method is that the resultant crude TiOPc does not include a halogenated TiOPc. When TiOPc includes a halogenated TiOPc as an impurity, the photosensitivity and charging properties of the resultant photoreceptor tend to deteriorate (as disclosed in collected papers of Japan Hardcopy'89, p103, 1989). In the present invention, the TiOPc disclosed in JOP 2001-19871, which does not include a halogenated TiOPc, is preferably used. Namely, the photoreceptor of the present invention does not use the technique which is disclosed in JOP 2001-115054 and which uses a TiOPc including a halogenated TiOPc.

Suitable binder resins for use in the charge generation layer of the photoreceptor of the present invention include polyvinyl acetal resins such as polyvinyl formal and polyvinyl butyral. The characteristics of polyvinyl acetal resins change depending on their polymerization degree, acetal degree, and contents of a hydroxyl group and an acetyl group. The polymerization degree is preferably from 500 to 5000 and more preferably from 1000 to 3000. In addition, the content of a hydroxyl group is preferably from 25 to 40% by mole and more preferably from 30 to 36% by mole. The formula of the preferable polyvinyl acetal resins is as follows:

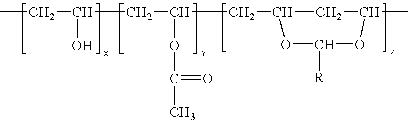

wherein R represents a hydrogen atom, or an alkyl group; X, Y and Z represent the ratio of the respective units, wherein X+Y+Z=1, and X is from 0.25 to 0.40, Y is from 0 to 0.1 and Z is from 0.60 to 0.75.

In the present invention, the average particle diameter of a charge generation material is measured by observing a charge generation layer, which is formed by coating a dispersion of the charge generation material, with an electron microscope. Charge generation materials typically have various forms such as rice grain form and needle form. In such a case, the particle diameter of several particles (at least 10 particles) of a charge generation material in the longitudinal direction thereof is measured to determine the arithmetic average of the particle diameter of the charge generation material.

The reason why the photoreceptor of the present invention, which does not use a halogen-containing solvent (i.e., which uses a non-halogenated solvent), has good photosensitivity and charging properties even when repeatedly used is not clear, but is considered to be as follows.

The present inventors formed a charge generation layer on an aluminum-deposited surface of a polyethylene terephthalate film, which layer has a smooth surface (i.e., less than 0.1 μm in ten-point mean roughness) using a charge generation layer coating liquid prepared in Example 1 described below. Then each of a halogen-containing solvent, dichloromethane, and a non-halogenated solvent, tetrahydrofuran, was coated on the charge generation layer and then dried. Then the surface of the charge generation layer was observed with an electron microscope.

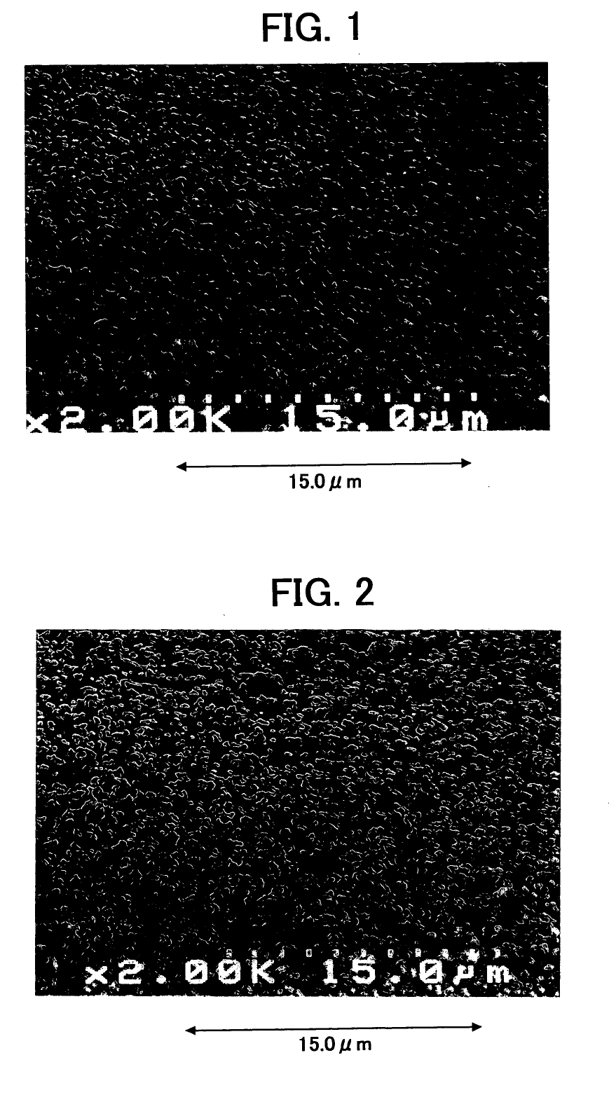

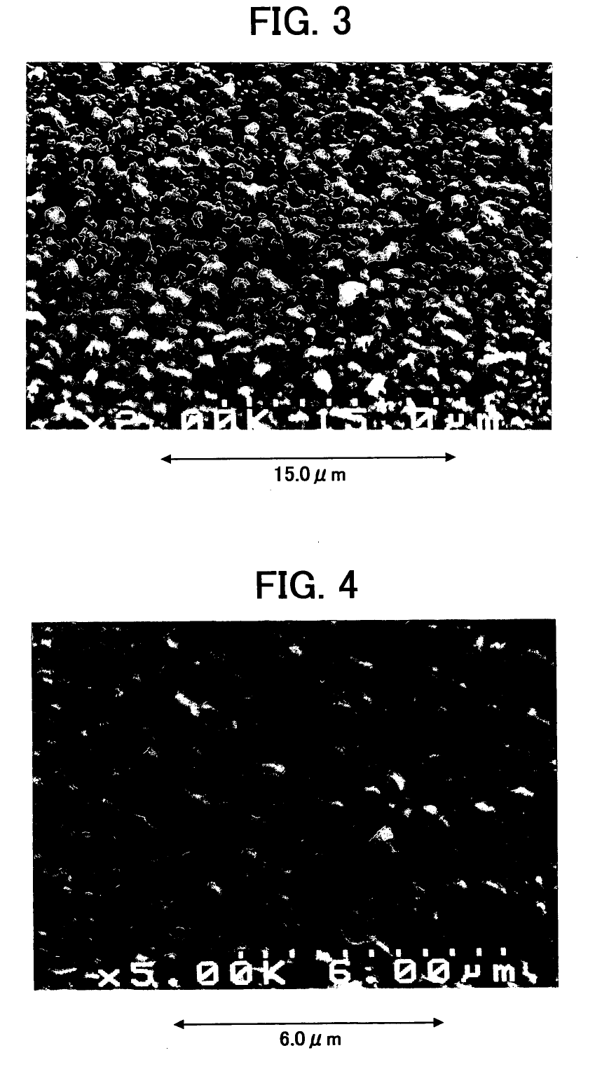

FIG. 1 is a photograph of the surface of the charge generation layer before coating the solvents. FIG. 2 is a photograph of the surface of the charge generation layer on which the halogen-containing solvent has been coated and then dried. FIG. 3 is a photograph of the surface of the charge generation layer on which the non-halogenated solvent has been coated and then dried.

As clearly understood from FIGS. 1 and 2, the surface shown in FIG. 2 is almost the same as that shown in FIG. 1, namely, the charge generation material does not agglomerate even after dichloromethane is coated thereon and then dried. In contrast, as clearly understood from FIG. 3, the charge generation material agglomerates (i.e., the particle diameter increases) when tetrahydrofuran is coated thereon and then dried. Thus, when a charge transport layer coating liquid including a non-halogenated solvent is coated on the charge generation layer, the surface condition of the charge generation layer significantly changes.

Namely, even when a charge generation layer is formed without agglomeration, the charge generation layer is agglomerated if a charge transport layer coating liquid including a non-halogenated solvent is coated thereon. Specifically, even when a charge generation layer in which a charge generation material is properly dispersed so as to have a small particle diameter is formed, the particle diameter of the charge generation material seriously increases if a charge transport layer coating liquid including a non-halogenated solvent is coated thereon. Therefore, the resultant photoreceptor has a charge generation layer in which a charge generation material having a large particle diameter is dispersed.

When an agglomerated charge generation material is present in the charge generation layer, photo carriers are not well generated. The reasons therefor are as follows.

One of the reasons is that when an agglomerated charge generation material is present, the distance between the carrier generation site (i.e., the center of a particle of the charge generation material) to the carrier injection site (i.e., the surface of the particle) at which the carrier is transferred from the charge generation material to a charge transport material increases. Therefore, the photo carriers generated in the center of particles tend to lose their activeness, resulting in deterioration of the carrier generation efficiency. The other of the reasons is that as the particle diameter of particles of a charge generation material increases, the surface area of the particles per unit weight decreases, and thereby the contact area between the charge generation material and the charge transport material surrounding the charge generation material decrease, resulting in deterioration of photo carrier injection efficiency. In any way, agglomeration of the charge generation material causes photo carrier generation efficiency to deteriorate, thereby causing problems such as deterioration of photosensitivity and increase of residual potential.

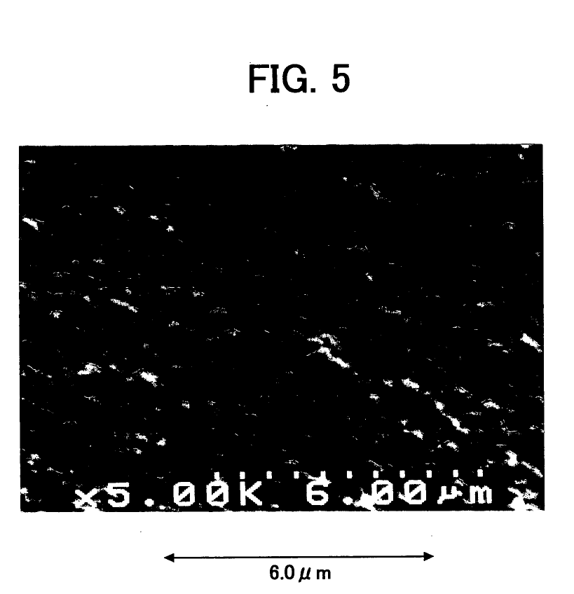

On the other hand, the agglomeration of the charge generation material in the charge generation layer is influenced by the roughness of the surface on which the charge generation layer is formed. FIGS. 4 and 5 are photographs of the surface of the charge generation layers which are formed on the same roughened substrate and on which a halogen-containing solvent is applied (FIG. 4) or a non-halogenated solvent is applied (FIG. 5). The conditions of both the surfaces are almost the same as those (not shown) of the surface of the charge generation layer before the solvents are applied. Namely, agglomeration of the charge generating material cannot be observed in these cases.

The reason therefor is not clear, but is considered to be as follows. When a charge generation layer is formed on a rough surface, the charge generation material located on a recessed portion of the rough surface cannot easily move, and thereby agglomeration tends not to occur. Thus, by using a charge generation material having an average particle diameter less than the roughness of the surface of a layer (or a substrate) on which the charge generation layer is formed, agglomeration of the charge generation material can be avoided.

The reason why the photoreceptor having a charge transport layer which is formed by coating a coating liquid including a non-halogenated solvent has good charging properties is considered to be that the photoreceptor is not affected by chlorine ions included in halogen-containing solvents.

In addition, the agglomeration of the charge generation material in the charge generation layer is greatly affected by the resin used together with the charge generation material. In particular, polyvinyl acetal resins having a polymerization degree of from 500 to 5000, and including a hydroxyl group in an amount of from 25 to 40% by mole have good characteristics. Further, polyvinyl acetal resins having a polymerization degree of from 1000 to 3000, and including a hydroxyl group in an amount of from 30 to 36% by mole have excellent characteristics.

The reason why agglomeration is influenced by the binder resin used is considered to be that the adhesion of the charge generation layer to the adjacent lower layer or the substrate and the dispersing state of the charge generation material in the binder resin, which influence on agglomeration, depend on the binder resin used.

The objects of the present invention cannot be attained by the conventional techniques disclosed in JOP 4-318557 in which phthalocyanine having a small particle diameter is used, JOP 2001-115054 in which a specific amount of halogenated titanyl phthalocyanine is used together with a titanyl phthalocyanine having a specific particle diameter, JOP 10-326023 in which a specific non-halogenated organic solvent is used, and JOP 2001-356506 in which a specific non-halogenated organic solvent is used together with a specific additive. The reason therefor is considered to be that the charge generation materials in the charge generation layers of these photoreceptors are agglomerated when the charge transport layers are formed thereon.

As mentioned above, the agglomeration of the charge generation material causes the photosensitivity of the resultant photoreceptor to deteriorate, resulting in production of undesired images such as low density images and images with background fouling. In the present invention, the agglomeration can be prevented by the methods as mentioned above, and thereby a photoreceptor having good photosensitivity and good charge properties can be provided.

In the present invention, the charge generation material included in the charge generation layer preferably has an average particle diameter not greater than 0.3 μm, and not greater than ⅔ of the ten-point mean roughness of the surface of the adjacent lower layer or the substrate, on which the charge generation layer is formed. When the charge generation material has such a particle diameter, the above-mentioned effects of the present invention can be fully produced, and thereby a photoreceptor having good photosensitivity and good charge properties can be provided.

The lower limit of the average particle diameter of the charge generation material is preferably from 0.05 μm to 0.2 μm in view of dispersion stability of the coating liquid and stability of the charge generation material, which is a crystal.

In order to prepare a charge generation layer including a charge generation material having an average particle diameter not greater than 0.3 μm, the following methods can be preferably used in the present invention.

One of the methods is that when a charge generation layer coating liquid is prepared, the coating liquid is subjected to a dispersion treatment such that the charge generation material therein has a specific average particle diameter, followed by filtering using a specific filter to remove a small amount of large particles.

The other of the methods is that the charge generation material to be used in the charge generation layer is synthesized while controlling the primary particle diameter thereof so as to be not greater than the predetermined particle diameter (i.e., the crystal conversion operation is stopped before the crystal has a particle diameter greater than the predetermined particle diameter).

Hereinafter the methods are explained in detail.

The titanyl phthalocyanine for use as the charge generation material in the charge generation layer, which has a maximum diffraction peak at a Bragg (2θ) angle of 27.2±0.2° when exposed to an X-ray of CuKα having a wavelength of 1.542 Å, tends to easily change the crystal form when being subjected to a dispersion treatment. Namely, although the TiOPc has an excellent photosensitivity, the TiOPc has such a drawback as to easily change its crystal form when receiving thermal and mechanical stresses.

When a part of the TiOPc causes a crystal conversion, the resultant crystal has a diffraction peak at an angle of 26.3°. This crystal has a lower photosensitivity than the TiOPc for use in the present invention, thereby causing problems such that the photosensitivity of the resultant photoreceptor deteriorates and undesired images are produced.

When the dispersion is performed mildly in attempting to avoid such problems, large particles tend to remain in the resultant dispersion. Such large particles cause to form black spot images when the images are visualized by a nega-posi developing method. Therefore, when the TiOPc mentioned above is used, it is necessary to avoid a trade-off such that when an average particle diameter of the TiOPc is decreased, the stability of the crystal of the TiOPc deteriorates.

Under such situation, an attempt to optimize the dispersion conditions of the charge generation layer coating liquid is made to prepare a coating liquid including charge generation particles, which achieve a more stable crystal state and have a particle diameter as small as possible.

However, when a normal dispersing machine is used for preparing a dispersion of the TiOPc, the TiOPc is pulverized between the dispersion media or between the dispersion media and the inside wall of the dispersing machine, resulting in formation of a dispersion including the TiOPc whose particle diameter distributes like a normal distribution curve. In addition, even when improved dispersing machines are used, the dispersing machines have a dead space (i.e., a space in which particles to be dispersed tend to remain there without being dispersed). Therefore, the resultant dispersion unavoidably includes a small amount of large particles.

Therefore, in general the dispersion operation is performed for a relatively long time to decrease the content of such large particles in the resultant dispersion. By using such a technique, the amount of large particles included in the resultant dispersion can be reduced, but when the dispersion operation is excessively performed, a problem in that the TiOPc changes its crystal form occurs.

In view of these facts, in the present invention large particles are securely removed from the dispersion. The method is as follows, but should be slightly changed depending on the dispersion machine used and the dispersion conditions.

When a TiOPc having a diffraction peak at an angle of 27.2° is synthesized, the TiOPc typically has a primary particle diameter of from about 0.2 to about 0.5 μm. It is possible to disperse the TiOPc so as to have a diameter not greater than such a primary particle diameter by using some improved dispersing machines. However, in this case the problem in that the TiOPc changes its crystal form tends to occur.

One of the preferable methods is that at first the TiOPc is dispersed so as to have a particle diameter nearly equal to the primary particle diameter, and then large particles having a particle diameter greater than the predetermined particle diameter and included in the dispersion are removed. As the method for removing the large particles, filtering is most preferable.

In the present invention, suitable filters should be selected and used depending on the particle diameter of the large particles to be removed. As a result of the present inventors' investigation, it is found that when a dispersion is used for a photoreceptor for use in image forming apparatus which are required to produce images having a resolution of about 600 dpi (dots per inch), particles having a particle diameter greater than 3 μm cause undesired images. Therefore, it is preferable to use a filter having an effective pore diameter not greater than 3 μm, and preferably not greater than 1 μm.

With respect to the effective pore diameter of filters, the smaller the effective pore diameter, the more perfectly large particles can be removed. However, the effective pore diameter is too small, particles which do not cause the problems are also removed from the dispersion. In addition, problems such that it takes a long time to subject a dispersion to a filtering treatment and the filter is frequently clogged with large particles, resulting in deterioration of filtering efficiency. Therefore it is preferable that the filter has such an effective pore diameter as mentioned above.

The material constituting the filter for use in the present invention has to have good resistance to the solvent included in the dispersion and coating liquid for use in the present invention. In order to efficiently perform the filtering operation, not only the average particle diameter of the dispersion but also the particle diameter distribution of the dispersion are important. Namely, when the particle diameter distribution is broad, problems such that the efficiency of the filtering operation deteriorates or the particles having a desired particle diameter are removed occur even though the average particle diameter is small.

The other method is that when the TiOPc is synthesized, the primary particle diameter of the TiOPc is controlled so as to be fine. When such a TiOPc is used, the stress to be applied to the TiOPc during the dispersion process can be reduced. As mentioned above, the TiOPc has a primary particle diameter of from 0.3 to 0.4 μm when normal synthesis methods are used. By using the method of synthesizing the TiOPc of the present invention, the resultant TiOPc has a primary particle diameter much smaller than the primary particle diameter (i.e., 0.3 to 0.4 μm).

The TiOPc having a diffraction peak at 27.2° is typically synthesized by the following method. At first, a crude TiOPc (i.e., a synthesized raw titanyl phthalocyanine) is synthesized by a know method. Then the crude TiOPc is re-precipitated using an acid paste method to prepare a TiOPc having an irregular form. The thus prepared TiOPc is treated by a proper organic solvent in the presence of water to prepare a TiOPc having the desired crystal form.

According to the present inventors' observation, the above-mentioned TioPc having an irregular form (i.e., a TiOPc having a low crystallinity) has a primary particle diameter not greater than 0.1 μm (specifically, almost all the particles have a primary particle diameter of from 0.01 to 0.05 μm). However, when the crystal conversion treatment is performed, the crystal grows, resulting in increase of the primary particle diameter.

In general, such a crystal conversion operation is performed while spending too much time thereon in order that a raw material does not remain in there sultant crystal. Namely, after the crystal conversion operation is performed for a time more than the time enough to change the crystal form, the resultant dispersion is filtered to prepare a TiOPc having the desired crystal form. Therefore, even when a raw material having a small primary particle diameter is used, the resultant TiOPc crystal has a relatively large primary particle diameter of from 0.3 to 0.4 μm.

Therefore, it is preferable in the crystal conversion process to complete the crystal conversion operation before crystal growth starts. Specifically, it is preferable that a proper solvent is used as the solvent for the crystal conversion to improve the crystal conversion efficiency; and a mixture of the solvent and a TiOPc having an irregular form is strongly agitated to fully contact the TiOPc with the solvent, resulting in completion of the crystal conversion process in a short time.

In order to complete the crystal conversion process in a short time, agitating devices having a strong agitator such as propellers or strong dispersing devices such as homogenizers and homomixers are preferably used. By using such dispersing machines, the raw material is fully converted to the desired TiOPc crystal without remaining in the resultant crystal while preventing crystal growth of the resultant TiOPc crystal.

As mentioned above, the particle diameter of the crystal particles increases in proportion to the crystal conversion time. Therefore, it is preferable that after the reaction (crystal conversion) is completed, the reaction is rapidly stopped. Specifically, it is preferable to use a method in which after the crystal conversion, a large amount of solvent hardly causing the crystal conversion is added to the dispersion. Suitable solvents for use as the solvent hardly causing the crystal conversion include alcohol solvents, ester solvents and the like.

By adding such solvents in an amount of about 10 times that of the solvent used for the crystal conversion, the crystal conversion processing can be stopped. By performing such a crystal conversion operation, a TiOPc having a relatively small primary particle diameter not greater than 0.3 μm can be prepared.

Namely, it is preferable to use the above-mentioned technique for preparing a TiOPc having a relatively small primary particle diameter in addition to the technique disclosed in JOP 2001-19871, in order to heighten the effects of the present invention.

The thus prepared TiOPc crystal is rapidly subjected to filtering to separate the crystal conversion solvent from the crystal. Filtering is performed using a filter including pores having a proper size. In this case, it is preferable to perform filtering under a reduced pressure.

The thus filtered TiOPc is dried upon application of heat thereto if desired. Suitable dryers for use in this drying process include known dryers. When drying is performed under a normal pressure, fan dryers are preferably used. In order to perform rapid drying, drying is preferably performed under a reduced pressure (preferably under a pressure not greater than 10 mmHg) because the effects of the present invention can be heightened. The drying methods performed under a reduced pressure are particularly preferably used for a material which decomposes or changes its crystal form at a high temperature.

The primary particles of the thus synthesized TiOPc have a relatively small particle diameter compared to those of primary crystals of conventional TiOPcs. Therefore, by properly controlling the dispersion conditions, a dispersion of a TiOPc having a small primary particle diameter and maintaining the desired crystal form can be prepared. Even in such a case, a very small amount of coarse particles can be included therein. Therefore, it is preferable to subject the dispersion to filtering.

By using any one of the methods mentioned above, the effects of the present invention can be further heightened.

In the photoreceptor of the present invention, it is necessary to subject the surface, on which the charge generation layer is to be formed, to a roughening treatment. Suitable roughening methods include the following methods:

(1) the surface of an electroconductive substrate is subjected to a cutting treatment:

(2) a honing process using a liquid;

(3) super finishing;

(4) dry or wet blasting;

(5) formation of an anodic oxide film; and the like.

When the surface is not roughened, the effects of the present invention cannot be produced. However, when the surface is excessively roughened, formation of the charge generation layer having the desired properties cannot be formed. Specifically, the roughness of the surface of the substrate (or the layer on which the charge generation layer is formed) is from 0.1 to 2 μm and preferably from 0.3 to 1.5 μm.

In order to improve the adhesion and coating properties of the charge generation layer and charging properties of the photoreceptor, an intermediate layer is preferably formed between the electroconductive substrate and the charge generation layer. The intermediate layer preferably includes an inorganic pigment, particularly a white pigment, in order to scatter the incident light, resulting in prevention of formation of an interference pattern. When a thick intermediate layer is formed, the surface thereof tends to have a smooth surface. In this case, it is preferable to form the intermediate layer while roughening the surface. Specifically, the intermediate layer is formed by dipping a substrate into an intermediate layer coating liquid and then pulling up the substrate while the surface of the coating liquid is vibrated by, for example, an ultrasonic machine or an agitating machine.

Alternatively, the surface of the intermediate layer can be roughened by vibrating the substrate when pulling up the substrate or blowing air to a wet intermediate layer right after the intermediate layer coating liquid is coated.

In addition, the surface of the intermediate layer can be roughened by forming a benard cell structure in the intermediate layer. The benard cell structure means that so-called orange peel is formed on a surface of the intermediate layer, resulting in formation of a roughened surface.

When a thin film is formed on a surface having a benard cell structure, the coating properties of the coated thin film tend to be deteriorated by the roughened lower layer. Therefore in general coating is performed such that a benard cell is not formed in the resultant layer. However, it is preferable in the present invention to form an intermediate layer while actively forming a benard cell structure therein. It is considered that the benard cell is formed due to convection in the coated liquid caused by difference in physical properties between the inside portion of the coated liquid and the surface portion thereof. As a result thereof, geometrical patterns are formed on the surface of the resultant layer. The convection easily occurs under the following conditions:

(1) the solvent included in the coating liquid has a large evaporation speed;

(2) the particles dispersed in the coating liquid have a wide particle diameter distribution;

(3) the coated liquid is thick;

(4) the coated liquid has a low viscosity;

(5) the coated liquid has a low surface tension;

(6) the concentration of the solvent in the atmosphere surrounding the coated liquid is low; and

(7) the temperature of the atmosphere surrounding the coated liquid is high.

By forming an intermediate layer under such conditions, the surface of the resultant intermediate layer has the desired roughness.

Similarly to the case of the electroconductive substrate, the effects of the present invention cannot be produced if the surface of the intermediate layer is not roughened. However, when the surface is excessively roughen, the desired charge generation layer cannot be formed. Therefore, the roughness of the intermediate layer is 0.1 to 2 μm, and preferably from 0.3 to 1.5 μm.

Then the photoreceptor of the present invention will be explained referring to drawings.

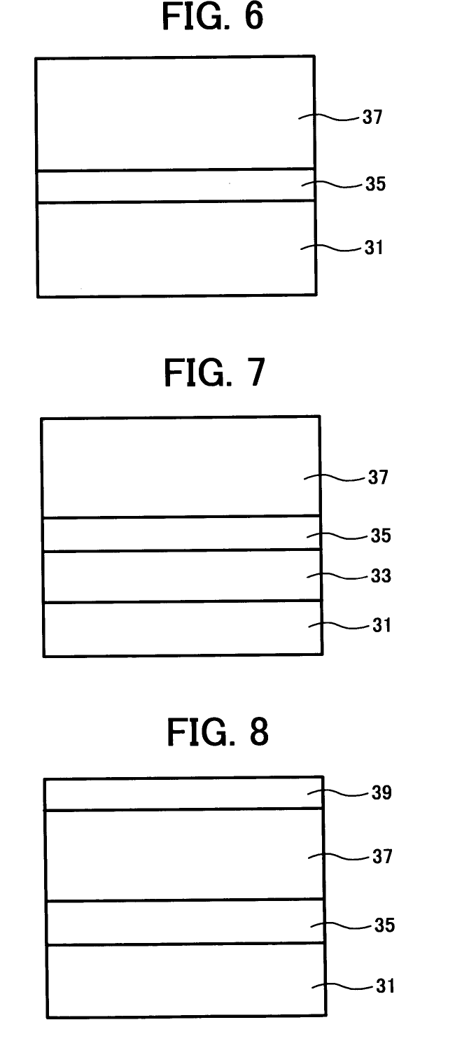

FIG. 6 is a schematic view illustrating the cross section of an embodiment of the photoreceptor of the present invention.

Referring to FIG. 6, a charge generation layer (hereinafter a CGL) 35 including a charge generation material (hereinafter a CGM) as a main component and a charge transport layer (hereinafter a CTL) 37 including a charge generation material (hereinafter a CTM) as a main component are overlaid on an electroconductive substrate 31 in this order.

FIG. 7 is a schematic view illustrating the cross section of another embodiment of the photoreceptor of the present invention.

Referring to FIG. 7, an intermediate layer 33, a CGL 35 including a CGM as a main component and a CTL 37 including a CTM as a main component are overlaid on an electroconductive substrate 31 in this order.

FIG. 8 is a schematic view illustrating the cross section of yet another embodiment of the photoreceptor of the present invention.

Referring to FIG. 8, a CGL 35 including a CGM as a main component, a CTL 37 including a CTM as a main component and a protective layer 39 are overlaid on an electroconductive substrate 31 in this order.

Suitable materials for use as the electroconductive substrate 31 include materials having a volume resistance not greater than 1×10¹⁰ Ω·cm. Specific examples of such materials include plastic cylinders, plastic films or paper sheets, on the surface of which a metal such as aluminum, nickel, chromium, nichrome, copper, gold, silver, platinum and the like, or a metal oxide such as tin oxides, indium oxides and the like, is formed by vapor deposition or sputtering. In addition, a plate of a metal such as aluminum, aluminum alloys, nickel and stainless steel can be used. A metal cylinder can also be used as the substrate 31, which is prepared by tubing a metal such as aluminum, aluminum alloys, nickel and stainless steel by a method such as impact ironing or direct ironing. Further, endless belts of a metal such as nickel, stainless steel and the like, which have been disclosed, for example, in published unexamined Japanese Patent Application No. 52-36016 can also be used as the substrate 31.

Among these materials, cylinders made of aluminum or an aluminum alloy are preferable because aluminum can be easily anodized. Suitable aluminum materials for use as the substrate include aluminum and aluminum alloys such as JIS 1000 series, 3000 series and 6000 series.

Anodic oxide films can be formed by anodizing metals or metal alloys in an electrolyte solution. Among the anodic oxide films, alumite films which can be prepared by anodizing aluminum or an aluminum alloy are preferably used for the photoreceptor of the present invention. This is because the resultant photoreceptor hardly causes undesired images such as black spots and background fouling when used for reverse development (i.e., nega-posi development).

The anodizing treatment is performed in an acidic solution including an acid such as chromic acid, sulfuric acid, oxalic acid, phosphoric acid, boric acid, and sulfamic acid. Among these acids, sulfuric acid is preferably used for the anodizing treatment in the present invention. It is preferable to perform an anodizing treatment on a substrate under the following conditions:

(1) concentration of sulfuric acid: 10 to 20%

(2) temperature of treatment liquid: 5 to 25° C.

(3) current density: 1 to 4 A/dm²

(4) electrolyzation voltage: 5 to 30 V

(5) treatment time: 5 to 60 minutes.

However, the treatment conditions are not limited thereto.

In this case, it is not preferable that the roughened surface of the substrate is smoothed by the anodizing treatment. Namely, the surface of the anodized substrate preferably has a roughness within the preferable range mentioned above (i.e., 0.1 to 2 μm, and preferably 0.3 to 1.5 μm).

The thus prepared anodic oxide film is porous and highly insulative. Therefore, the surface of the substrate is very unstable, and the physical properties of the anodic oxide film change with time. In order to avoid such a problem, the anodic oxide film is preferably subjected to a sealing treatment. The sealing treatment can be performed by, for example, the following methods:

(1) the anodic oxide film is dipped in an aqueous solution of nickel fluoride or nickel acetate;

(2) the anodic oxide film is dipped in a boiling water; and

(3) the anodic oxide film is subjected to steam sealing.

After the sealing treatment, the anodic oxide film is subjected to a washing treatment to remove foreign materials such as metal salts adhered to the surface of the anodic oxide film during the sealing treatment. Such foreign materials present on the surface of the substrate not only affect the coating quality of a layer formed thereon but also produce images having background fouling because of typically having a low electric resistance. The washing treatment is performed by washing the substrate having an anodic oxide film thereon with pure water one or more times. It is preferable that the washing treatment is performed until the washing water is as clean (i.e., deinonized) as possible. In addition, it is also preferable to rub the substrate with a washing member such as brushes in the washing treatment.

The thickness of the thus prepared anodic oxide film is preferably from 5 to 15 μm. When the anodic oxide film is too thin, the barrier effect thereof is not satisfactory. In contrast, when the anodic oxide film is too thick, the time constant of the electrode (i.e., the substrate) becomes excessively large, resulting in increase of residual potential of the resultant photoreceptor and deterioration of response thereof.

As mentioned above, the photoreceptor of the present invention can include an intermediate layer between the electroconductive substrate 31 and the CGL 35. The intermediate layer 33 includes a resin as a main component. Since a CGL is formed on the intermediate layer typically by coating a liquid including an organic solvent, the resin in the intermediate layer preferably has good resistance to general organic solvents.

Specific examples of such resins include water-soluble resins such as polyvinyl alcohol resins, case in and polyacrylic acid sodium salts; alcohol soluble resins such as nylon copolymers and methoxymethylated nylon resins; and thermosetting resins capable of forming a three-dimensional network such as polyurethane resins, melamine resins, alkyd-melamine resins, epoxy resins and the like.

The intermediate layer may include a fine powder of metal oxides such as titanium oxide, silica, alumina, zirconium oxide, tin oxide and indium oxide to prevent occurrence of moire in the resultant images and to decrease residual potential of the resultant photoreceptor.

The intermediate layer can be formed by coating a coating liquid using a proper solvent and a proper coating method. When the intermediate layer is formed, the surface of the intermediate layer is preferable roughened by vibrating the coating liquid and/or the substrate, or performing coating under conditions under which a benard cell structure is formed.

The intermediate layer may be formed using a silane coupling agent, titanium coupling agent or a chromium coupling agent. In addition, a layer of aluminum oxide which is formed by an anodic oxidation method and a layer of an organic compound such as polyparaxylylene or an inorganic compound such as SiO, SnO₂, TiO₂, ITO or CeO₂ which is formed by a vacuum evaporation method is also preferably used as the intermediate layer. In addition, the intermediate layer can also be formed by any known methods. The thickness of the intermediate layer is preferably 0 to 5 μm.

Then the photosensitive layer will be explained.

As mentioned above, a multi-layer type photosensitive layer constituted of the CGL 35 and the CTL 37 is preferably used in the present invention because of having good sensitivity and good durability. The CGL 35 includes the organic pigment mentioned above as a main component.

The CGL 35 is prepared by coating a coating liquid, which is prepared by dispersing the organic pigment and a resin such as polyvinyl acetal resins in a proper solvent, on an electroconductive substrate and then drying the coated liquid.

Suitable solvents for use in the CGL coating liquid include non-halogenated solvents such as isopropanol, acetone, methyl ethyl ketone, cyclohexanone, tetrahydrofuran, dioxane, ethyl cellosolve, ethyl acetate, methyl acetate, cyclohexane, toluene, xylene, ligroin, and the like solvents. In particular, ketone type solvents, ester type solvents and ether type solvents are preferably used. These solvents can be used alone or in combination.

The coating liquid is typically prepared by dispersing the pigment in a dispersion medium using a dispersion machine applying mechanical energy such as compression, sheer stress, abrasion, trituration, rubbing, impact and vibration, such as ball mills, vibration mills, disc vibration mills, attritors, sand mills, bead mills, paint shakers, jet mills and ultrasonic dispersing machines.

Suitable coating methods for use in the CGL coating include dip coating methods, spray coating methods, bead coating methods, nozzle coating methods, spin coating methods, ring coating methods and the like methods. The thickness of the CGL 35 is preferably from 0.01 to 5 μm, and more preferably from 0.1 to 2 μm. The photoreceptor of the present invention has high photosensitivity and good charging properties even when the CGL has a thickness not greater than 0.2 μm.

The CTL 37 can be formed, for example, by the following method:

(1) a CTM and a binder resin are dispersed or dissolved in a proper solvent such as non-halogenated solvents, e.g., tetrahydrofuran, dioxolan, dioxane, toluene, xylene, and their derivatives, to prepare a CTL coating liquid; and

(2) the coating liquid is coated on the CGL and then dried to form a CTL.

The CTL coating liquid may include one or more additives such as plasticizers, leveling agents, antioxidants and the like, if desired.

CTMs are classified into positive-hole transport materials and electron transport materials.

Specific examples of the electron transport materials include electron accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetanitroxanthone, 2,4,8-trinitrothioxanthone, 2,6,8-trinitro-4H-indeno[1,2-b]thiophene-4-one, 1,3,7-trinitrodibenzothiphene-5,5-dioxide, benzoquinone derivatives and the like.

Specific examples of the positive-hole transport materials include known materials such as poly-N-carbazole and its derivatives, poly-γ-carbazolylethylglutamate and its derivatives, pyrene-formaldehyde condensation products and their derivatives, polyvinyl pyrene, polyvinyl phenanthrene, polysilane, oxazole derivatives, oxadiazole derivatives, imidazole derivatives, monoarylamines, diarylamines, triarylamines, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, and the like.

These CTMs can be used alone or in combination.

Specific examples of the binder resin for use in the CTL 37 include known thermoplastic resins and thermosetting resins, such as polystyrene, styrene-acrylonitrile copolymers, styrene-butadiene copolymers, styrene-maleic anhydride copolymers, polyester, polyvinyl chloride, vinyl chloride-vinyl acetate copolymers, polyvinyl acetate, polyvinylidene chloride, polyarylate, phenoxy resins, polycarbonate, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like. Among these resins, polycarbonate resins are preferably used because of having good electric properties and good abrasion resistance.

The content of the CTM in the CTL 37 is preferably from 20 to 300 parts by weight, and more preferably from 40 to 150 parts by weight, per 100 parts by weight of the binder resin included in the CTL 37. The thickness of the CTL 37 is preferably from 5 to 100 μm.

The CTL 37 preferably includes a charge transport polymer, which has both a binder resin function and a charge transport function, because the resultant CTL has good abrasion resistance. When the abrasion resistance of a photoreceptor is improved, increase of electric field formed on the photoreceptor can be prevented even when the photoreceptor is repeatedly used for a long period of time, and there by the effect of the present invention can be further heightened.

Suitable charge transport polymers include known charge transport polymer materials. Among these materials, polycarbonate resins having a triarylamine group in their main chain and/or side chain are preferably used. In particular, charge transport polymers having the following formulae (2) to (11) are preferably used:

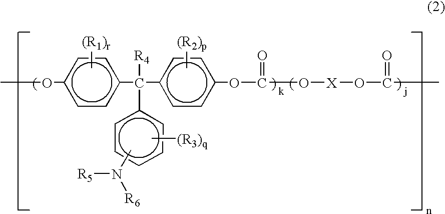

wherein R₁, R₂ and R₃ independently represent a substituted or unsubstituted alkyl group, or a halogen atom; R₄ represents a hydrogen atom, or a substituted or unsubstituted alkyl group; R₅, and R₆ independently represent a substituted or unsubstituted aryl group; r, p and q independently represent 0 or an integer of from 1 to 4; k is a number of from 0.1 to 1.0 and j is a number of from 0 to 0.9; n is an integer of from 5 to 5000; and X represents a divalent aliphatic group, a divalent alicyclic group or a divalent group having the following formula:

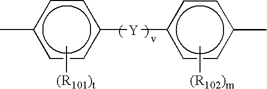

wherein R₁₀₁ and R₁₀₂ independently represent a substituted or unsubstituted alkyl group, a substituted or unsubstituted aryl group, or a halogen atom; t and m represent 0 or an integer of from 1 to 4; v is 0 or 1; and Y represents a linear alkylene group, a branched alkylene group, a cyclic alkylene group, —O—, —S—, —SO—, —SO₂—, —CO—, —CO—O—Z—O—CO— (Z represents a divalent aliphatic group), or a group having the following formula:

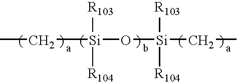

wherein a is an integer of from 1 to 20; b is an integer of from 1 to 2000; and R₁₀₃ and R₁₀₄ independently represent a substituted or unsubstituted alkyl group, or a substituted or unsubstituted aryl group, wherein R₁₀₁, R₁₀₂, R₁₀₃ and R₁₀₄ may be the same or different from the others.

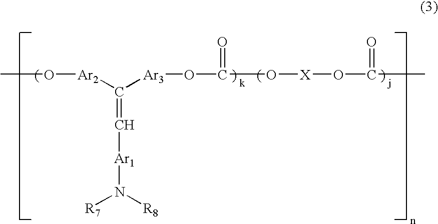

wherein R₇ and R₈ independently represent a substituted or unsubstituted aryl group; Ar₁, Ar₂ and Ar₃ independently represent an arylene group; and X, k, j and n are defined above in formula (2).

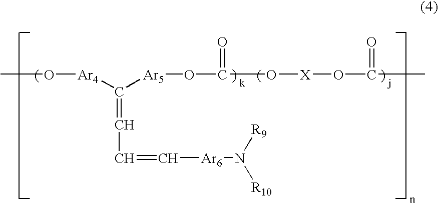

wherein R₉ and R₁₀ independently represent a substituted or unsubstituted aryl group; Ar₄, Ar₅ and Ar₆ independently represent an arylene group; and X, k, j and n are defined above in formula (2).

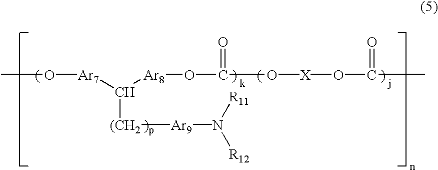

wherein R₁₁ and R₁₂ independently represent a substituted or unsubstituted aryl group; Ar₇, Ar₈ and Ar₉ independently represent an arylene group; p is an integer of from 1 to 5; and X, k, j and n are defined above in formula (2).

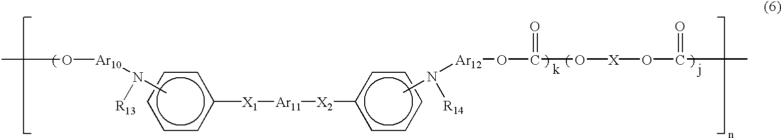

wherein R₁₃ and R₁₄ independently represent a substituted or unsubstituted aryl group; Ar₁₀, Ar₁₁, and Ar₁₂ independently represent an arylene group; X₁ and X₂ independently represent a substituted or unsubstituted ethylene group, or a substituted or unsubstituted vinylene group; and X, k, j and n are defined above in formula (2).

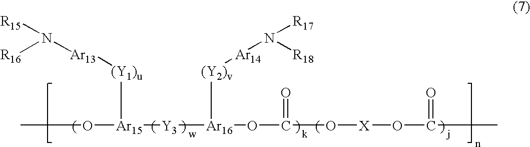

wherein R₁₅, R₁₆, R₁₇ and R₁₈ independently represent a substituted or unsubstituted aryl group; Ar₁₃, Ar₁₄, Ar₁₅ and Ar₁₆ independently represent an arylene group; Y₁, Y₂ and Y₃ independently represent a substituted or unsubstituted alkylene group, a substituted or unsubstituted cycloalkylene group, a substituted or unsubstituted alkyleneether group, an oxygen atom, a sulfur atom, or a vinylene group; u, v and w independently represent 0 or 1; and X, k, j and n are defined above in formula (2).

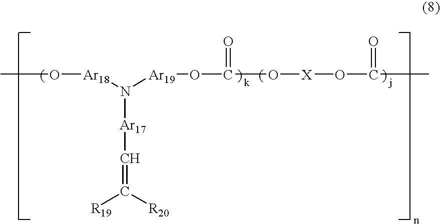

wherein R₁₉ and R₂₀ independently represent a hydrogen atom, or substituted or unsubstituted aryl group, and R₁₉ and R₂₀ optionally share bond connectivity to form a ring; Ar₁₇, Ar₁₈ and Ar₁₉ independently represent an arylene group; and X, k, j and n are defined above in formula (2).

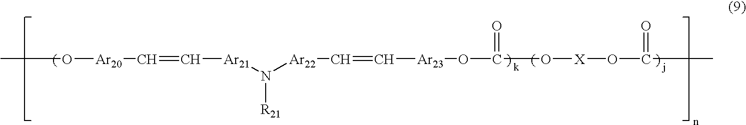

wherein R₂₁ represents a substituted or unsubstituted aryl group; Ar₂₀, Ar₂₁, Ar₂₂ and Ar₂₃ independently represent an arylene group; and X, k, j and n are defined above in formula (2).

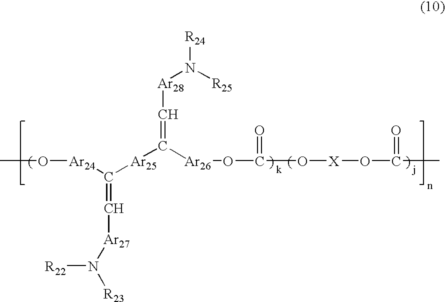

wherein R₂₂, R₂₃, R₂₄ and R₂₅ independently represent a substituted or unsubstituted aryl group; Ar₂₄, Ar₂₅, Ar₂₆, Ar₂₇ and Ar₂₈ independently represent an arylene group; and X, k, j and n are defined above in formula (2).

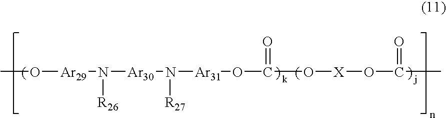

wherein R₂₆ and R₂₇ independently represent a substituted or unsubstituted aryl group; Ar₂₉, Ar₃₀ and Ar₃₁ independently represent an arylene group; and X, k, j and n are defined above in formula (2).

In addition, the CTL can also be formed by coating one or more monomers or oligomers, which have an electron donating group and then subjecting the monomers or oligomers to a crosslinking reaction after forming the layer such that the layer has a two- or three-dimensional structure.

The CTL constituted of a polymer or a crosslinked polymer, which has an electron donating group, has good abrasion resistance. In general, in electrophotographic image forming apparatus, the potential of the charge formed on a photoreceptor (i.e., the potential of a non-image area) is set to be constant. Therefore, the larger the abrasion amount of the surface layer of the photoreceptor, the larger the electric field formed on the photoreceptor.

When the electric field increases, background fouling occurs in the resultant images. Namely a photoreceptor having good abrasion resistance hardly causes the background fouling problem. The above-mentioned CTL constituted of a polymer having an electron donating group has good film formability because the layer itself a polymer. In addition, the CTL has good charge transportability because of including charge transport moieties at a relatively high concentration compared to charge transport layers including a polymer and a low molecular weight charge transport material. Namely, the photoreceptor including a CTL constituted of a charge transport polymer has high response.

Known copolymers, block polymers, graft polymers, and star polymers can also be used for the polymers having an electron donating group. In addition, crosslinking polymers including an electron donating group, which have been disclosed in published unexamined Japanese Patent Applications Nos. 3-109406, 2000-206723, and 2001-34001, can also be used therefor.

The CTL may include additives such as plasticizers and leveling agents. Specific examples of the plasticizers include known plasticizers such as dibutyl phthalate and dioctyl phthalate. The content of the plasticizer in the CTL is from 0 to 30% by weight based on the binder resin included in the CTL. Specific examples of the leveling agents include silicone oils such as dimethyl silicone oils and methyl phenyl silicone oils, and polymers and oligomers, which include a perfluoroalkyl group in their side chain. The content of the leveling agent in the CTL is from 0 to 1% by weight based on the binder resin included in the CTL.

In the photoreceptor of the present invention, a protective layer 39 is optionally formed on the photosensitive layer to protect the photosensitive layer. Recently, computers are used in daily life, and therefore a need exists for a high-speed and small-sized printer. By forming a protective layer on the photoreceptor of the present invention, the resultant photoreceptor has improved durability while having a high sensitivity and producing images without causing undesired images. Such photoreceptor can be preferably used for the printer mentioned above.

Specific examples of the material for use in the protective layer include ABS resins, ACS resins, olefin-vinyl monomer copolymers, chlorinated polyether, aryl resins, phenolic resins, polyacetal, polyamide, polyamideimide, polyallysulfone, polybutylene, polybutyleneterephthalate, polycarbonate, polyarylate, polyethersulfone, polyethylene, polyethyleneterephthalate, polyimide, acrylic resins, polymethylpentene, polypropylene, polyphenyleneoxide, polysulfone, polystyrene, AS resins, butadiene-styrene copolymers, polyurethane, polyvinyl chloride, polyvinylidene chloride, epoxy resins, fluorine-containing resins such as polytetrafluoroethylene, silicone resins, etc.

In addition, combinations of such resins and an inorganic filler such as titanium oxide, aluminum oxide, tin oxide, zinc oxide, zirconium oxide, magnesium oxide, potassium titanate and silica can also be used. These inorganic fillers may be subjected to a surface-treatment.

In addition, organic and inorganic fillers can be used in the protective layer. Suitable organic fillers include powders of fluorine-containing resins such as polytetrafluoroethylene, silicone resin powders, amorphous carbon powders, etc. Specific examples of the inorganic fillers include powders of metals such as copper, tin, aluminum and indium; metal oxides such as alumina, silica, tin oxide, zinc oxide, titanium oxide, alumina, zirconia, indium oxide, antimony oxide, bismuth oxide, calcium oxide, tin oxide doped with antimony, indium oxide doped with tin; potassium titanate, etc. In view of hardness, the inorganic fillers are preferable. In particular, silica, titanium oxide and alumina are preferable. Among these fillers, α-alumina having a hexagonal closest packing structure is most preferable.

The preferable content of the filler in the protective layer is preferably determined depending on the species of the filler used and the application of the resultant photoreceptor, but is preferably not less than 5% by weight, more preferably from 10 to 50% by weight, and even more preferably from 10 to 30% by weight, based on total weight of the protective layer.

The filler included in the protective layer preferably has a volume average particle diameter of from 0.1 to 2 μm, and more preferably from 0.3 to 1 μm. When the average particle diameter is too small, the resultant protective layer has insufficient abrasion resistance. In contrast, when the average particle diameter is too large, the surface of the resultant protective layer is seriously roughened or a problem such that a protective layer itself cannot be formed occurs.

In the present application, the average particle diameter of a filler means a volume average particle diameter unless otherwise specified, and is measured using an instrument, CAPA-700 manufactured by Horiba Ltd. In this case, the cumulative 50% particle diameter (i.e., the median particle diameter) is defined as the average particle diameter. In addition, it is preferable that the standard deviation of the particle diameter distribution curve of the filler used in the protective layer is not greater than 1 μm. When the standard deviation is too large (i.e., when the filler has too broad particle diameter distribution), the effect of the present invention cannot be produced.

The pH of the filler used in the protective layer coating liquid largely influences on the dispersibility of the filler therein and the resolution of the images produced by the resultant photoreceptor. The reason therefor is that fillers (in particular, metal oxides) typically include hydrochloric acid therein which is used during the production of the fillers. When the residual amount of hydrochloric acid is large, the resultant photoreceptor tends to produce blurred images. In addition, inclusion of too large an amount of hydrochloric acid causes the dispersibility of the filler to deteriorate.

Another reason therefor is that the charge properties of fillers (in particular, metal oxides) are largely influenced by the pH of the fillers. In general, particles dispersed in a liquid are charged positively or negatively. In order to neutralize the charge of the particles, ions having a charge opposite to the charge of the particles gather around the particles, resulting in formation of an electric double layer, and thereby the particles are stably dispersed in the liquid. The potential (i.e., zeta potential) of a point around one of the particles decreases (i.e., approaches to zero) as the distance between the point and the particle increases. Namely, a point far apart from the particle is electrically neutral, i.e., the zeta potential thereof is zero. In this case, the higher the zeta potential, the better the dispersion of the particles. When the zeta potential is nearly equal to zero, the particles easily aggregate. The zeta potential of a system largely depends on the pH of the system. When the system has a certain pH, the zeta potential becomes zero. This point is called an isoelectric point. It is preferable to increase the zeta potential by setting the pH of the system to be far apart from the isoelectric point, in order to stabilize the dispersion of the system.

It is preferable in the photoreceptor of the present invention to use a filler having a pH of 5 or more at the isoelectric point, in order to prevent formation of blurred images. In other words, fillers having a highly basic property can be preferably used in the photoreceptor of the present invention because the effect of the present invention can be heightened. Fillers having a highly basic property have a high zeta potential (i.e., the fillers are stably dispersed) when the system for which the fillers are used is acidic.

In this application, the pH of a filler means the pH of the filler at the isoelectric point, which is determined by the zeta potential of the filler. Zeta potential is measured by a laser beam potential meter manufactured by Ootsuka Electric Co., Ltd.

In addition, in order to prevent production of blurred images, fillers having a high electric resistance (i.e., not less than 1×10¹⁰ Ω·cm in resistivity) are preferably used. Further, fillers having a pH not less than 5 and a dielectric constant not less than 5 while having a resistivity not less than 1×10¹⁰ Ω·cm are more preferably used. Fillers having a dielectric constant not less than 5 and/or a pH not less than 5 can be used alone or in combination. In addition, combinations of a filler having a pH not less than 5 and a filler having a pH less than 5, or combinations of a filler having a dielectric constant not less than 5 and a filler having a dielectric constant less than 5, can also be used. Among these fillers, α-alumina having a closest packing structure is preferably used. This is because α-alumina has a high insulating property, a high heat stability and a good abrasion resistance, resulting in prevention of formation of blurred images and improvement of abrasion resistance of the resultant photoreceptor.

In the present application, the resistivity of a filler is defined as follows. The resistivity of a powder such as fillers largely changes depending on the filling factor of the powder when the resistivity is measured. Therefore, it is necessary to measure the resistivity under a constant condition. In the present application, the resistivity is measured by a device similar to the devices disclosed in published unexamined Japanese Patent Applications Nos. 5-94049 (FIG. 1) and5-113688 (FIG. 1). The surface area of the electrodes of the device is 4.0 cm². Before the resistivity of a sample powder is measured, a load of 4 kg is applied to one of the electrodes for 1 minute and the amount of the sample powder is adjusted such that the distance between the two electrodes becomes 4 mm.

The resistivity of the sample powder is measured by pressing the sample powder only by the weight of the upper electrode without applying any other load to the sample. The voltage applied to the sample powder is 100 V. When the resistivity is not less than 10⁶ Ω·cm, HIGH RESISTANCEMETER (from Yokogawa Hewlett-Packard Co.) is used to measure the resistivity. When the resistivity is less than 10⁶ Ω·cm, a digital multimeter (from Fluke Corp.) is used.

The dielectric constant of a filler is measured as follows. A cell similar to that used for measuring the resistivity is also used for measuring the dielectric constant. After a load is applied to a sample powder, the capacity of the sample powder is measured using a dielectric loss measuring instrument (from Ando Electric Co., Ltd.) to determine the dielectric constant of the powder.

The fillers for use in the protective layer are preferably subjected to a surface treatment using a surface treatment agent in order to improve the dispersion of the fillers in the protective layer. When a filler is poorly dispersed in the protective layer, the following problems occur.

(1) the residual potential of the resultant photoreceptor increases;

(2) the transparency of the resultant protective layer decreases;

(3) coating defects are observed in the resultant protective layer;

(4) the abrasion resistance of the protective layer deteriorates;

(5) the durability of the resultant photoreceptor deteriorates; and

(6) the image qualities of the images produced by the resultant photoreceptor deteriorate.

Suitable surface treatment agents include known surface treatment agents. However, surface treatment agents which can maintain the highly insulative property of the fillers used are preferably used.

As the surface treatment agents, titanate coupling agents, aluminum coupling agents, zircoaluminate coupling agents, higher fatty acids, combinations of these agents with a silane coupling agent, Al₂O₃, TiO₂, ZrO₂, silicones, aluminum stearate, and the like, can be preferably used to improve the dispersibility of fillers and to prevent formation of blurred images. These materials can be used alone or in combination.

When fillers treated with a silane coupling agent are used, the resultant photoreceptor tends to produce blurred images. However, combinations of a silane coupling agent with one of the surface treatment agents mentioned above can often produce good images without blurring.

The coating weight of the surface treatment agents is preferably from 3 to 30% by weight, and more preferably from 5 to 20% by weight, based on the weight of the treated filler although the weight is determined depending on the average primary particle diameter of the filler.

When the content of the surface treatment agent is too low, the dispersibility of the filler cannot be improved. In contrast, when the content is too high, the residual potential of the resultant photoreceptor seriously increases.

These fillers can be dispersed using a proper dispersion machine. In this case, the fillers are preferably dispersed so as to be separated into the primary particles thereof, in view of transparency of the resultant protective layer.

In addition, a CTM can be included in the protective layer to enhance the photo response and to reduce the residual potential of the resultant photoreceptor. The CTMs mentioned above for use in the CTL can also be used in the protective layer.

When a low molecular weight CTM is used as the CTM in the protective layer, the concentration of the CTM may be changed in the thickness direction of the protective layer. Namely, it is preferable to reduce the concentration of the CTM at the surface portion of the protective layer in order to improve the abrasion resistance of the resultant photoreceptor. At this point, the concentration of the CTM means the ratio of the weight of the CTM to the total weight of the protective layer.

It is preferable to use a charge transport polymer in the protective layer in order to improve the durability of the photoreceptor. By using a combination of a polymer with a filler, not only the abrasion resistance (i.e., a mechanical property) of the photoreceptor, but also a chemical stability thereof can be improved. In general, polymers have a relatively poor reactivity compared to that of low molecular weight compounds. Namely, charge transport polymers have good resistance to acidic gasses generated by charging members and good resistance to the sputtering effect due to discharging of the charging members.

When a layer having a high abrasion resistance is formed on the surface of a photoreceptor, the blurred image problem tends to occur when the photoreceptor is repeatedly used. This is because acidic gasses are adsorbed on the surface of the layer and/or low resistance materials adhere on the surface thereof. However, when the protective layer is constituted of a filler and a polymer, the number of the absorption cites is relatively small compared to other protective layers. When the number of the absorption cites decreases, formation of blurred images can be prevented.

The protective layer can be formed by any known coating methods. The thickness of the protective layer is preferably from 1 to 10 μm. In addition, layers of amorphous carbon or amorphous silicon carbide, which are formed by a vacuum deposition method can also be used as the protective layer.

Then the image forming apparatus of the present invention, which includes the photoreceptor of the present invention, will be explained in detail.

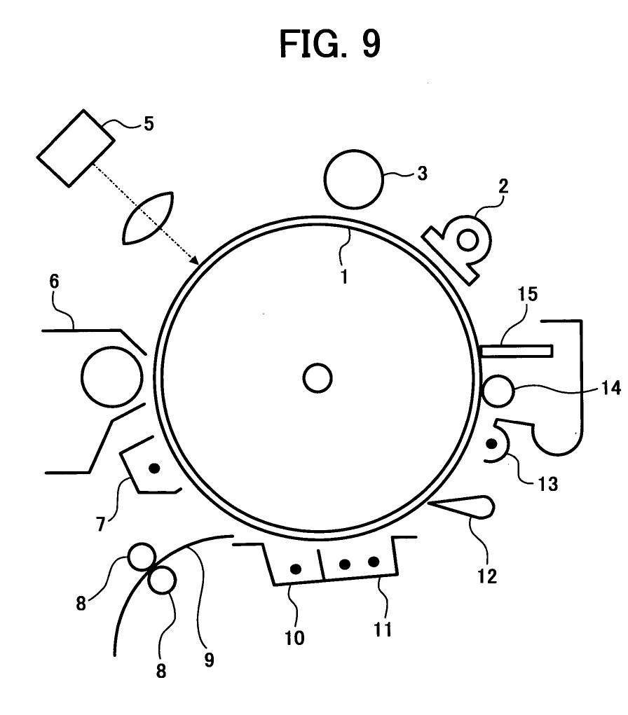

FIG. 9 is a schematic view for explaining an embodiment of the image forming apparatus of the present invention.

In FIG. 9, numeral 1 denotes a photoreceptor. In this case, the photoreceptor has a cylindrical form, but sheet-form photoreceptors and endless belt-form photoreceptors can also be used. The photoreceptor 1 is the photoreceptor of the present invention.

Around the photoreceptor 1, a discharging lamp 2 configured to discharge the charges remaining on the photoreceptor 1, a charger 3 configured to charge the photoreceptor 1, an imagewise light irradiator 5 configured to irradiate the photoreceptor 1 with imagewise light to form an electrostatic latent image on the photoreceptor 1, an image developer 6 configured to develop the latent image with a toner to form a toner image on the photoreceptor 1, and a cleaning unit including a cleaning brush 14 and a cleaning blade 15 configured to clean the surface of the photoreceptor 1 are arranged while contacting or being set closely to the photoreceptor 1. The toner image formed on the photoreceptor 1 is transferred on a receiving paper 9 fed by a pair of registration rollers 8 at the transfer device (i.e., a pair of a transfer charger 10 and a separating charger 11). The receiving paper 9 having the toner image thereon is separated from the photoreceptor 1 by a separating pick 12.

In the image forming apparatus of the present invention, a pre-transfer charger 7 and a pre-cleaning charger 13 may be arranged if desired.

As the charger 3, the pre-transfer charger 7, the transfer charger 10, the separating charger 11 and the pre-cleaning charger 13, all known chargers such as corotrons, scorotrons, solid state chargers, roller chargers and brush chargers can be used.

As the charging devices, contact chargers such as charging rollers, charging blades and charging brushes and proximity chargers which charge a photoreceptor while a small gap is formed between the charging member and the photoreceptor are preferably used. In particular, by using contact chargers, the amount of generated ozone can be drastically reduced, and therefore the photoreceptor can be maintained to be stable and deterioration of image qualities can be prevented when the photoreceptor is repeatedly used. In addition, the image forming apparatus can be minimized in size.

Among the contact chargers, charging rollers and charging brushes can be preferably used in the present invention.

In the proximity chargers for use in the image forming apparatus of the present invention, the gap between the proximity charging member and the photoreceptor is about 200 μm, and therefore the proximity chargers are different from known non-contact chargers such as corotrons and scorotrons. Any mechanisms which can maintain such a small gap between the charging member and the photoreceptor to be charged, can be used for the proximity chargers for use in the image forming apparatus of the present invention. For example, proximity chargers disclosed in published unexamined Japanese Patent Applications Nos. 2002-148904 and 2002-148905 are preferably used in the image forming apparatus of the present invention.

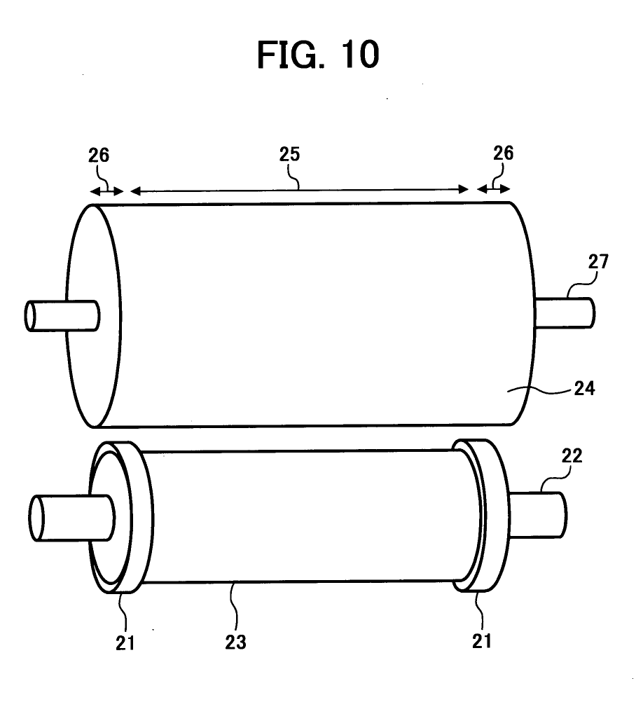

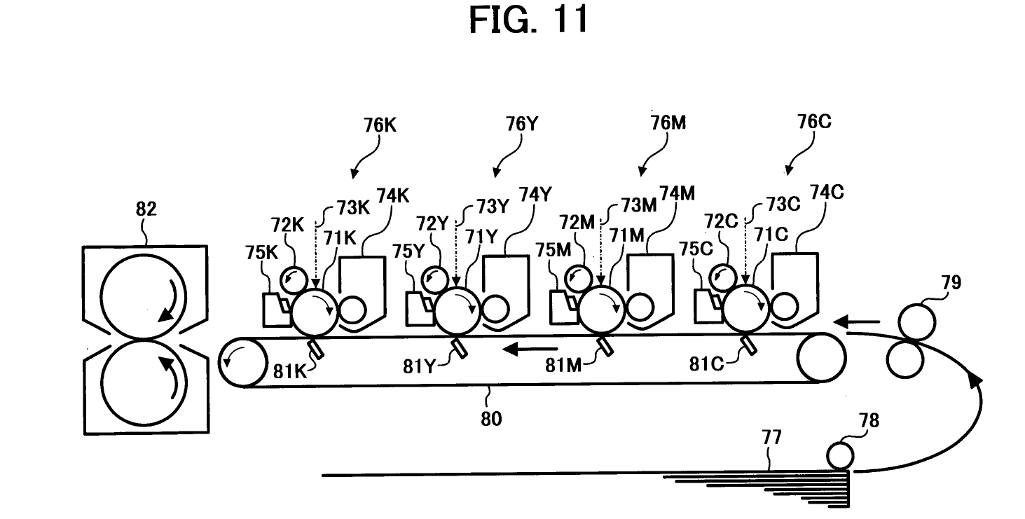

FIG. 10 is a schematic view illustrating an embodiment of the proximity charger for use in the present invention, in which a gap forming member is formed on a charger. Referring to FIG. 10, numerals 21, 22 and 23 represent gap forming members, a charging area of the charger and a rotating shaft of the charger. Numerals 24, 25, 26 and 27 represent the photoreceptor of the present invention, an image forming area of the photoreceptor, non-image areas of the photoreceptor 24, and a rotating shaft of the photoreceptor 24. The gap forming members 21 contact the non-image areas 26 of the photoreceptor 24 to form a gap between the image forming area 25 and the charging area 23. In this case, the rotating shafts 22 and 27 may be mechanically fixed with a member such as belts to maintain a proper gap.

The above-mentioned proximity charger has the following advantages:

(1) the charge efficiency is high;

(2) the amount of ozone generated during charging is little;

(3) the image forming apparatus can be minimized in size;

(4) the charger is hardly contaminated by the toner used; and

(5) the surface of the photoreceptor is hardly abraded.

Suitable light sources for use in the imagewise light irradiator 5 and the discharging lamp 2 include fluorescent lamps, tungsten lamps, halogen lamps, mercury lamps, sodium lamps, light emitting diodes (LEDs), laser diodes (LDs), light sources using electroluminescence (EL), and the like. In addition, in order to obtain light having a desired wave length range, filters such as sharp-cut filters, band pass filters, near-infrared cutting filters, dichroic filters, interference filters, color temperature converting filters and the like can be used.

Among these light sources, LEDs, and LDs are preferably used because of emitting a high energy light beam having a wavelength of from 600 nm to 800 nm, to which the TiOPc in the CGL has high sensitivity.

The above-mentioned lamps can be used for not only the processes mentioned above and illustrated in FIG. 9, but also other processes using light irradiation, such as a transfer process including light irradiation, a discharging process, a cleaning process including light irradiation and a pre-exposure process.

When the toner image formed on the photoreceptor 1 by the developing unit 6 is transferred onto the receiving paper 9, all of the toner particles of the toner image are not transferred on the receiving paper 9, and residual toner particles remain on the surface of the photoreceptor 1. The residual toner particles are removed from the photoreceptor 1 by the fur blush 14 or the cleaning blade 15. The residual toner particles remaining on the photoreceptor 1 can be removed by only a cleaning brush. Suitable cleaning blushes include known cleaning blushes such as fur blushes and mag-fur blushes.

When the photoreceptor 1 which is previously charged positively (or negatively) is exposed to imagewise light, an electrostatic latent image having a positive or negative charge is formed on the photoreceptor 1. When the latent image having a positive (or negative) charge is developed with a toner having a negative (or positive) charge, a positive image can be obtained. In contrast, when the latent image having a positive (negative) charge is developed with a toner having a positive (negative) charge, a negative image (i.e., a reversal image) can be obtained. As the developing method, known developing methods can be used. In addition, as the discharging methods, known discharging methods can also be used.

Another embodiment of the image forming apparatus of the present invention will be explained in detail. The image forming apparatus is an image forming apparatus capable of producing full color images, and includes four image forming units which can produce respective color images and include a photoreceptor, a charger, a developing device and a cleaner, respectively. The image forming units can be fixedly set in the image forming apparatus, or may be detachably set therein.

FIG. 11 is a schematic view illustrating another embodiment of the image forming apparatus (a tandem type image forming apparatus) of the present invention, which includes plural image forming units. However, the image forming apparatus of the present invention is not limited thereto.

In FIG. 11, the tandem type image forming apparatus has a cyan image forming unit 76C, a magenta image forming unit 76M, a yellow image forming unit 76Y and a black image forming unit 76K. Drum photoreceptors 71C, 71M, 71Y and 71K rotate in the direction indicated by the respective arrows. Around the photoreceptors 71C, 71M, 71Y and 71K, chargers 72C, 72M, 72Y and 72K, image developers 74C, 74M, 74Y and 74K, and cleaners 75C, 75M, 75Y and 75K are arranged in this order in the clockwise direction. As the chargers, the above-mentioned chargers which can uniformly charge the surface of the photoreceptors are preferably used. Imagewise light irradiators 73C, 73M, 73Y and 73K irradiate a surface of the respective photoreceptors located between the chargers and the image developers with laser light to form an electrostatic latent image on the respective photoreceptors. The four image forming units 76C, 76M, 76Y and 76K are arranged along a transfer belt 80. The transfer belt 80 contacts the respective photoreceptor 71C, 71M, 71Y or 71K at an image transfer point located between the respective image developer and the respective cleaner to receive color images formed on the photoreceptors. At the backsides of the image transfer points of the transfer belt 80, transfer brushes 81C, 81M, 81Y and 81K are arranged to apply a transfer bias to the transfer belt 80.

The image forming process will be explained referring to FIG. 11.

At first, in each of the image forming units 76C, 76M, 76Y and 76K, the photoreceptor 71C, 71M, 71Y or 71K is charged with the charger 72C, 72M, 72Y or 72K which rotates in the direction indicated by an arrow. Then an image irradiator (not shown) irradiates each of the photoreceptors 71C, 71M, 71Y and 71K with laser light 73C, 73M, 73Y or 73K to form an electrostatic latent image on each photoreceptor.

Then the electrostatic latent image on each photoreceptor is developed with the image developer 74C, 74M, 74Y or 74K including a color toner C, M, Y or K to form a color toner image on each photoreceptor. The thus prepared color toner images are transferred onto a receiving material 77 fed from a paper tray.

The receiving material 77 is fed by a feeding roller 78 and stops at a pair of registration rollers 79, and is timely fed to the transfer belt 80 such that the color toner images formed on each photoreceptor are transferred onto proper positions of the receiving material 77. Each of the toner images on the photoreceptors is transferred onto the receiving material 77 at the contact point (i.e., the transfer position) of the photoreceptor and the receiving material 77.

The toner image on each photoreceptor is transferred onto the receiving material 77 due to an electric field which is formed due to the difference between the transfer bias voltage and the potential of the photoreceptor. After passing through the four transfer positions, the receiving material 77 having the color toner images thereon is then transported to a fixer 82 so that the color toner images are fixed to the receiving material 77. Then the receiving material 77 is discharged from the main body of the image forming apparatus. Toner particles, which remain on the photoreceptors even after the transfer process, are collected by respective cleaners 75C, 75M, 75Y and 75K.

In the image forming apparatus, the image forming units 76C, 76M, 76Y and 76K are arranged in this order in the paper feeding direction, but the order is not limited thereto.

When a black image is formed, the other image forming units 76C, 76M and 76Y may be stopped. In addition, in FIG. 11, the chargers 72C, 72M, 72Y and 72K contact the respective photoreceptors 71C, 71M, 71Y and 71K, but the chargers may be proximity charges in which a proper gap of from 10 to 200 μm is formed between the charging members and the respective photoreceptors. Such proximity chargers have advantages such that the abrasion of the photoreceptors and the chargers can be reduced, and in addition a toner film is hardly formed on the charging members.

The above-mentioned image forming units may be fixedly set in an image forming apparatus such as copiers, facsimiles or printers. However, the image forming units may be detachably set therein as a process cartridge. The process cartridge means an image forming unit which includes at least a photoreceptor and at least one of a charger, an imagewise light irradiator, and an image developer. An image transferring device, a cleaner, and a discharger are optionally provided in the process cartridge. The process cartridge can be used for monochrome image forming apparatus and full color image forming apparatus.

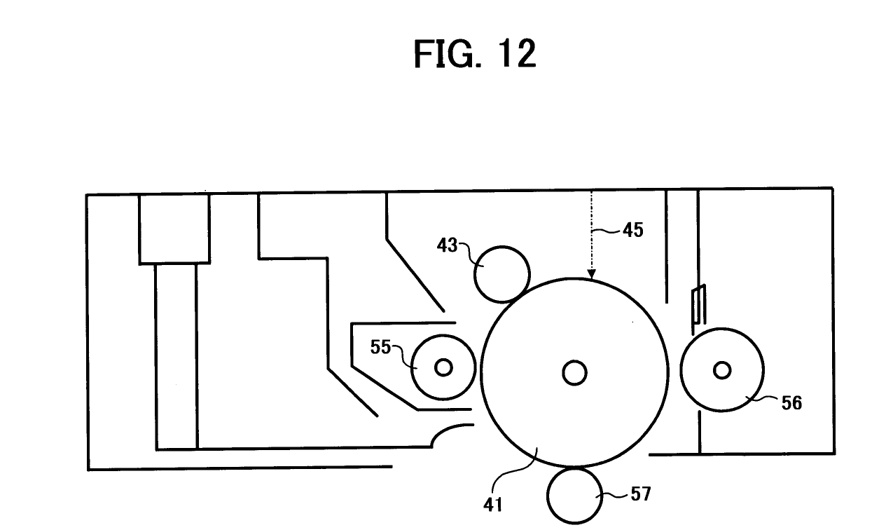

FIG. 12 is a schematic view illustrating an embodiment of the process cartridge of the present invention.

Referring to FIG. 12, the process cartridge includes a photoreceptor 41, a charger 43 configured to charge the photoreceptor 41, a cleaning brush 55 configured to clean the surface of the photoreceptor 41, an image developer (a developing roller) 56 configured to develop the latent image formed on the photoreceptor 41 with a toner, and an image transferring device 57 configured to transfer the toner image onto a receiving material. Imagewise light 45, which is emitted by an imagewise light irradiator (not shown), irradiates the photoreceptor 41 to form an electrostatic latent image on the photoreceptor 41. The photoreceptor 41 is the photoreceptor of the present invention

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

At first, synthesis examples of charge generation materials will be explained.

### Synthesis Example 1

In a container, 29.2 g of 1,3-diiminoisoindoline and 200 ml of sulforane were mixed while stirring. Under a nitrogen gas flow, 20.4 g of titanium tetrabutoxide were dropped therein. After the addition of titanium tetrabutoxide was completed, the temperature of the mixture was gradually increased to 180° C. The temperature of the mixture was maintained at a temperature in a range of from 170° C. to 180° C. for 5 hours while stirring the mixture to react the compounds. After the reaction was terminated, the reaction product was cooled. Then the reaction product was filtered to obtain the precipitate. Then the precipitate was washed with chloroform until the precipitate colored blue. The precipitate was then washed with methanol several times, and further washed with hot water of 80° C. several times. Thus a crude TiOPc was prepared.

One part of the thus prepared crude TiOPc was gradually added to 20 parts of concentrated sulfuric acid to be dissolved therein. The solution was gradually added to 100 parts of ice water while stirred, to precipitate a crystal. The crystal was obtained by filtering. The crystal was washed until the filtrate became neutral (i.e., until the pH thereof became 7). Two grams of the thus prepared wet cake of a TiOPc pigment were added to 20 g of tetrahydrofuran and stirred for about 4 hours. Then 100 g of methanol were added to the mixture and then the mixture was agitated for 1 hour. The mixture was subjected to filtering, and then the solid components were dried. Thus, a TiOPc powder of Synthesis Example 1 was prepared.

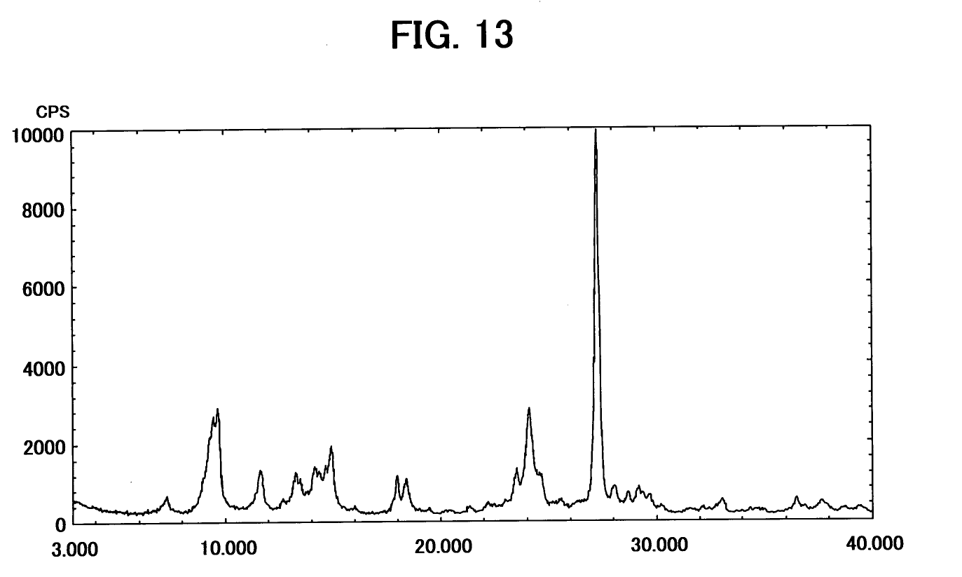

When the TiOPc powder was subjected to an X-ray diffraction analysis using a Cu—Kα X-ray having a wavelength of 1.542 Å, the TiOPc powder had an X-ray diffraction spectrum in which a maximum peak is observed at a Bragg (2θ) angle of 27.2±0.2°, and a lowest angle peak at an angle of 7.3±0.2°, wherein no peak is observed in an angle range of from 7.4° to 9.4° (i.e., the interval between the lowest angle peak to the next peak at the high angle side is 2.0 or more) and at an angle of 26.3. The X-ray diffraction spectrum is illustrated in FIG. 13.

The measuring conditions were as follows:

X-ray tube: Cu

Voltage: 50 kV

Current: 30 mA

Scanning speed: 2°/min

Scanning range: 30 to 40°

Time constant: 2 seconds

### Synthesis Example 2

A TiOPc crystal was prepared by the method disclosed in Example 1 in published unexamined Japanese Patent Application No. 1-299874 (i.e., Japanese Patent No., 2,584,682). The method is as follows:

The wet cake of the titanyl phthalocyanine pigment prepared in Synthesis Example 1 was dried. One gram of the dried pigment was added in polyethylene glycol of 50 g. The mixture was dispersed using a mill in which glass beads of 100 g were included. After this crystal change operation, the pigment was subjected to a washing treatment with dilute sulfuric acid followed by washing with a sodium hydroxide aqueous solution. The washed pigment was dried. Thus a TiOPc crystal of Synthesis Example 2 was prepared.

### Synthesis Example 3

A TiOPc crystal was prepared by the method disclosed in Manufacturing Example 1 in published unexamined Japanese Patent Application No. 3-269064 (i.e., Japanese Patent No. 2,584,682). The method is as follows:

The wet cake of the titanyl phthalocyanine pigment prepared in Synthesis Example 1 was dried. One gram of the dried pigment was added in a mixture solvent of 100 g of a deionized water and 1 g of monochlorobenzene. The mixture was stirred for 1 hour at 50° C. After this operation, the pigment was subjected to a washing treatment with methanol followed by a washing treatment with deionized water. The washed pigment was dried.

Thus a TiOPc crystal of Synthesis Example 3 was prepared.

### Synthesis Example 4

A TiOPc crystal was prepared by the method disclosed in Manufacturing Example in published unexamined Japanese Patent Application No. 2-8256 (i.e., published examined Japanese Patent Application No. 7-91486). The method is as follows:

In a container, 9.8 grams of phthalodinitrile and 75 ml of 1-chloronaphthalene were contained and mixed while stirring. Under a nitrogen gas flow, 2.2 ml of titanium tetrachloride were dropped therein. After the addition of titanium tetrachloride was completed, the temperature of the mixture was gradually increased to 200° C. The temperature of the mixture was maintained at a temperature in a range of from 200° C. to 220° C. for 3 hours while stirring the mixture to react the compounds. After the reaction was terminated, the reaction product was cooled. When the reaction product was cooled to 130° C., the reaction product was filtered to obtain the precipitate. Then the precipitate was washed with 1-chloronaphthalene until the precipitate colored blue. The precipitate was then subjected to a washing treatment with methanol several times, followed by a washing treatment with hot water of 80° C. several times. Then the washed pigment was dried.

Thus a TiOPc of Synthesis Example 4 was prepared.

### Synthesis Example 5

A TiOPc crystal was prepared by the method disclosed in Synthesis Example 1 in published unexamined Japanese Patent Application No. 64-17066 (i.e., published examined Japanese Patent Application No. 7-97221). The method is as follows:

Five (5). parts of α-form TiOPc, 10 parts of sodium chloride, and 5 parts of acetophenone were mixed and subjected to a crystal changing treatment at 100° C. for 10 hours using a sand grinder. The crystal was subjected to a washing treatment with deionized water followed by a washing treatment with methanol. The crystal was refined using a dilute sulfuric acid, and then washed with deionized water until the washing water included no sulfuric acid. Then the crystal was dried to prepare a TiOPc crystal of Synthesis Example 5.

### Synthesis Example 6

A TiOPc crystal was prepared by the method disclosed in Example 1 in published unexamined Japanese Patent Application No. 11-5919 (i.e., Japanese Patent No. 3,003,664). The method is as follows:

At first, 20.4 parts of o-phthalodinitrile and 7.6 parts of titanium tetrachloride were reacted in 50 parts of quinoline at 200° C. for 2 hours. Then the solvent was removed therefrom by a steam distillation. The reaction product was subjected to a refining treatment with a 2% aqueous solution of hydrochloric acid followed by a refining treatment with a 2% aqueous solution of sodium hydroxide. Then the reaction product was subjected to a washing treatment with methanol followed by a washing treatment with N,N-dimethyl formamide. The washed pigment was dried to prepare a TiOPc of Synthesis Example 6.

Then two parts of the thus prepared TiOPc were gradually added to 40 parts of 98% sulfuric acid at 5° C. to be dissolved therein. The mixture was agitated for about 1 hour while maintaining the temperature at 5° C. Then the sulfuric acid solution was gradually added to 400 parts of an ice water while the mixture was agitated at a high speed. The mixture was subjected to filtering to obtain a crystal. The crystal was subjected to a washing treatment with distilled water until the washing water included no acid. Thus, a wet cake was obtained. The wet cake was added to 100 parts of tetrahydrofuran, and the mixture was agitated for about 5 hours, followed by filtering, washing with tetrahydrofuran and drying. Thus, a TiOPc of Synthesis Example 6 was prepared.

### Synthesis Example 7

A TiOPc crystal was prepared by the method disclosed in Synthesis Example 2 in published unexamined Japanese Patent Application No. 3-255456 (i.e., Japanese Patent No. 3,005,052). The method is as follows:

At first, 10 parts of the wet cake prepared in Synthesis Example 1 mentioned above were mixed with 15 parts of sodium chloride and 7 parts of diethylene glycol. The mixture was milled with an automatic mortar for 60 hours at 80° C. Then the wet cake was subjected to a washing treatment to perfectly remove sodium chloride and diethylene glycol included therein. The washed compound was dried under a reduced pressure, and then was milled for 30 minutes together with 200 parts of cyclohexanone using a sand mill which contained glass beads having a diameter of 1 mm. Thus, a TiOPc pigment of Synthesis Example 7 was prepared.

The thus prepared pigments of Synthesis Examples 2 to 7 were subjected to the X-ray diffraction analysis to obtain the diffraction spectra thereof. As a result, the spectra thereof are the same as those described in the disclosed documents mentioned above. The angles of the peaks of the X-ray diffraction spectra of the pigments of Synthesis Examples 1 to 7 are shown in Table 1.

TABLE 1

| | | Lowest | | | Peak in | |
|---|---|---|---|---|---|---|
| | Max. | angle | | | a range | |
| | Peak | peak | Peak at | Peak at | of 7.4° | Peak at |
| | (°) | (°) | 9.4° | 9.6° | to 9.6° | 26.3° |
| Synthesis | 27.2 | 7.3 | Yes | Yes | No | No |
| Ex. 1 | | | | | | |
| Synthesis | 27.2 | 7.3 | No | No | No | No |
| Ex. 2 | | | | | | |
| Synthesis | 27.2 | 9.6 | Yes | Yes | No | No |
| Ex. 3 | | | | | | |
| Synthesis | 27.2 | 7.4 | No | Yes | No | No |
| Ex. 4 | | | | | | |
| Synthesis | 27.2 | 7.3 | Yes | Yes | Yes | No |
| Ex. 5 | | | | | (7.5°) | |
| Synthesis | 27.2 | 7.5 | No | Yes | Yes | No |
| Ex. 6 | | | | | (7.5°) | |
| Synthesis | 27.2 | 7.4 | No | No | Yes | Yes |
| Ex. 7 | | | | | (9.2°) | |

### Synthesis Example 8

In a container, 292 parts of 1,3-diiminoisoindoline and 1800 parts of sulforane were mixed while stirring. Under a nitrogen gas flow, 204 parts of titanium tetrabutoxide were dropped therein. After the addition of titanium tetrabutoxide was completed, the temperature of the mixture was gradually increased to 180° C. The temperature of the mixture was maintained at a temperature in a range of from 170° C. to 180° C. for 5 hours while stirring the mixture to react the compounds. After the reaction was terminated, the reaction product was cooled. Then the reaction product was filtered to obtain the precipitate. Then the precipitate was washed with chloroform until the precipitate colored blue. The precipitate was then subjected to a washing treatment with methanol several times followed by a washing treatment with hot water of 80° C. several times and drying. Thus a crude TiOPc was prepared.

Sixty parts of the thus prepared crude TiOPc were gradually added to 1000 parts of 96% sulfuric acid at a temperature of 3 to 5° C. to be dissolved therein. After being subjected to filtering, the solution was gradually added to 35,000 parts of ice water while agitating to precipitate a crystal. The crystal was obtained by filtering. The crystal was washed until the filtrate became neutral (i.e., until the pH thereof became 7). Thus, an aqueous paste of a TiOPc pigment was prepared.

The 1,500 parts of tetrahydrofuran were added to the aqueous paste and the mixture was strongly agitated at a revolution of 2000 rpm by a homomixer (MARKII f model from Kenis Ltd.) at room temperature. When the color of dark blue of the paste changed to light blue (at a time about 20 minute after the start of agitating), the agitating was stopped and then the paste was subjected to a vacuum filtering treatment.

The crystal obtained by the filtering was washed with tetrahydrofuran. Thus, 98 parts of a wet cake of a pigment were prepared. The paste was dried at 70° C. for 2 days under a reduced pressure (5 mmHg). Thus, 78 parts of a TiOPc crystal were prepared.

When the TiOPc crystal was subjected to the X-ray diffraction analysis, the TiOPc crystal had the same spectrum as that of the TiOPc obtained in Synthesis Example 1.

In this case, the synthesized dispersions in Synthesis Examples 1 and 8 were sampled by a net, which is made of copper and whose surface had been subjected to an electroconductive treatment, just before the filtering treatment, and observed with a transmission electron microscope (H-9000NAR from Hitachi Ltd., hereinafter referred to as a TEM) of 75,000 power magnification to measure the particle sizes of the TiOPcs prepared in Synthesis Examples 1 and 8. The average particle diameter thereof was determined as follows.

The images of particles of a TiOPc in the TEM were photographed. Among the particles (needle form particles) of the TiOPc in the photograph, 30 particles were randomly selected to measure the lengths of the particles in the long axis direction. The lengths were averaged to determined the average particle diameter of the TiOPc.

As a result, the TiOPcs crystal prepared in Synthesis Example 8 and 1 had an average primary particle diameter of about 0.15 μm and 0.25 μm, respectively.

### Example 1

Preparation of CGL

A CGL coating liquid was prepared by subjecting the following components to bead milling. In this case, the milling was controlled such that the average particle diameter of the pigment became 0.2 μm.

| | |
|---|---|
| TiOPc pigment prepared in Synthesis Example 1 | 15 |
| Polyvinyl butyral | 10 |
| (S-LEC BX-1 from Sekisui Chemical Co., Ltd.) | |
| Methyl ethyl ketone | 600 |

The thus prepared CGL coating liquid was coated on an aluminum drum (specified in JIS1050), which has an outside diameter of 30 mm and a length of 340 mm and which had been subjected to a cutting treatment so as to have a surface having a roughness of 1.0 μm, by a dip coating method. Then the coated liquid was dried for 20 minutes at 80° C. Thus, a CGL having a thickness of 0.2 μm was prepared.

The surface of the CGL was observed with a reflection electron microscope (S-4700 from Hitachi Ltd., hereinafter referred to as a SEM) of 50,000 power magnification. Similarly to the above-mentioned method, 30 particles were randomly selected to determine the average particle diameter of the TiOPc in the CGL. As a result, the average particle diameter was almost the same as that in the coating liquid (i.e., 0.2 μm)

Preparation of CTL

The following components were mixed to prepare a CTL coating liquid.

| | |
|---|---|
| Polycarbonate | 10 |
| (IUPILON from Mitsubishi Gas Chemical co., Ltd.) | 8 |
| CTM having the following formula (12) | |
| 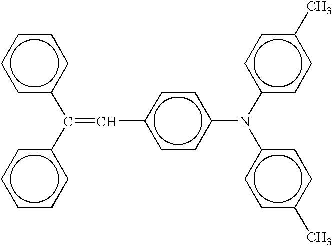 | (12) |
| Tetrahydrofuran (THF) | 80 |

The thus prepared CTL coating liquid was coated on the CGL and then dried for 20 minutes at 130° C. Thus a CTL having a thickness of 25 μm was prepared.

Thus, a photoreceptor of Example 1 was prepared.

### Examples 2

Preparation of Intermediate Layer

The following components were mixed to prepare an intermediate layer coating liquid.

| | |
|---|---|
| Titanium oxide | 70 |
| (CR-EL, from Ishihara Sangyo Kaisha K. K.) | |
| Alkyd resin | 15 |
| (BEKKOLITE M6401-50-S from Dainippon Ink And Chemicals, | |
| Inc., solid content of 50%) | |
| Melamine resin | 10 |
| (SUPER BEKKAMINE L-121-60 from Dainippon Ink And | |
| Chemicals, Inc., solid content of 60%) | |
| Methyl ethyl ketone | 100 |

The intermediate layer coating liquid was dip-coated on an aluminum drum which had been prepared by the same method as in Example 1, and then dried for 20 minutes at 130° C. Thus, an intermediate layer having a thickness of 3 μm was prepared. The roughness of the surface of the intermediate layer was 0.6 μm.

Then the procedure for preparation of the CGL and CTL in Example 1 was repeated to prepare a photoreceptor of Example 2.

### Example 3

The procedure for preparation of the photoreceptor in Example 1 was repeated except that the roughness of the cut surface of the aluminum drum was changed from 1.0 μm to 0.3 μm.

Thus, a photoreceptor of Example 2 was prepared.

### Comparative Example 1

The procedure for preparation of the photoreceptor in Example 1 was repeated except that an aluminum drum which had not been subjected to a cutting treatment and which has a surface roughness less than 0.05 μm was used as the substrate. The outside diameter and length of the aluminum drum were 30 mm and 340 mm, respectively.

Thus, a photoreceptor of Comparative Example 1 was prepared.

### Example 4

The intermediate layer coating liquid prepared in Example 2 was dip-coated on an aluminum drum which had been prepared by the same method as performed in Comparative Example 1. In this case, ultrasound was applied to the coating liquid when dip coating was performed. The coated liquid was dried for 20 minutes at 130° C. The thickness and the surface roughness of the intermediate layer were 3 μm and 0.4 μm, respectively.

Then the procedure for preparation of the CGL and CTL in Example 1 was repeated to prepare a photoreceptor of Example 4.

### Example 5 and Comparative Examples 2 to 5

The procedures for preparation of the photoreceptors in Examples 1 to 4 and Comparative Example 1 were repeated except that the average particle diameter of the CGM in the CGL coating liquid was changed from 0.2 μm to 0.6 μm by changing the bead milling conditions. Thus, photoreceptors of Example 5 and Comparative Examples 2 to 5 were prepared.

### Example 6 and Comparative Example 6

The procedures for preparation of the photoreceptors in Example 1 and Comparative Example 1 were repeated except that the solvent (i.e., tetrahydrofuran) of the CTL coating liquid was replaced with dioxolan to prepare photoreceptors of Example 6 and Comparative Example 6.

### Example 7 and Comparative Example 7

The procedures for preparation of the photoreceptors in Example 1 and Comparative Example 1 were repeated except that the solvent (i.e., 80 parts of tetrahydrofuran) of the CTL coating liquid was replaced with a mixture solvent of 50 parts of tetrahydrofuran and 30 parts of toluene to prepare photoreceptors of Example 7 and Comparative Example 7.

### Reference Example 1

The procedure for preparation of the photoreceptor in Example 1 was repeated except that the solvent (i.e., tetrahydrofuran) of the CTL coating liquid was replaced with dichloromethane to prepare a photoreceptor of Reference Example 1.

### Reference Example 2

The procedure for preparation of the photoreceptor in Example 1 was repeated except that the solvent (i.e., tetrahydrofuran) of the CTL coating liquid was replaced with chloroform to prepare a photoreceptor of Reference Example 2.

### Example 8

The procedure for preparation of the photoreceptor in Example 2 was repeated except that the TiOPc pigment of the CGL coating liquid was replaced with the TiOPc of Synthesis Example 2 to prepare a photoreceptor of Example 8.

### Example 9

The procedure for preparation of the photoreceptor in Example 2 was repeated except that the TiOPc pigment of the CGL coating liquid was replaced with the TiOPc of Synthesis Example 3 to prepare a photoreceptor of Example 9.

### Example 10

The procedure for preparation of the photoreceptor in Example 2 was repeated except that the TiOPc pigment of the CGL coating liquid was replaced with the TiOPc of Synthesis Example 4 to prepare a photoreceptor of Example 10.

### Example 11

The procedure for preparation of the photoreceptor in Example 2 was repeated except that the TiOPc pigment of the CGL coating liquid was replaced with the TiOPc of Synthesis Example 5 to prepare a photoreceptor of Example 11.

### Example 12

The procedure for preparation of the photoreceptor in Example 2 was repeated except that the TiOPc pigment of the CGL coating liquid was replaced with the TiOPc of Synthesis Example 6 to prepare a photoreceptor of Example 12.

### Example 13

The procedure for preparation of the photoreceptor in Example 2 was repeated except that the TiOPc pigment of the CGL coating liquid was replaced with the TiOPc of Synthesis Example 7 to prepare a photoreceptor of Example 13.

### Example 14

The procedure for preparation of the photoreceptor in Example 2 was repeated except that the TiOPc pigment of the CGL coating liquid was replaced with the TiOPc of Synthesis Example 8 to prepare a photoreceptor of Example 14.

### Example 15

The procedure for preparation of the photoreceptor in Example 2 was repeated except that the CGL coating liquid was subjected to a filtering treatment using a cotton wind cartridge filter TWC-3-CS having an effective pore diameter of 3 μm and made by ADVANTECH before coating. When performing filtering, a pump was used to perform pressure filtering.

Thus, a photoreceptor of Example 15 was prepared.

Each of the CGL coating liquids of Examples 2 to 15, which was coated on a slide glass, was observed with a microscope of 250 power magnification to determine whether large particles are present therein. As a result, no large particles were not observed in the CGL coating liquid of Example 15 but a few large particles were observed in the CGL coating liquid of Example 2.

### Example 16

The procedure for preparation of the photoreceptor in Example 1 was repeated except that the polyvinyl butyral (S-LEC BX-1 from Sekisui Chemical Co., Ltd.) was replaced with a polyvinyl butyral (S-LEC BM-S from Sekisui Chemical Co., Ltd.) to prepare a photoreceptor of Example 16.

### Comparative Example 8

The procedure for preparation of the photoreceptor in Example 1 was repeated except that the polyvinyl butyral (S-LEC BX-1 from Sekisui Chemical Co., Ltd.) was replaced with a melamine resin (MELAN 289 from Hitachi Chemical Co., Ltd.) to prepare a photoreceptor of Comparative Example 8.

Evaluation

Each of the thus prepared photoreceptors was set in a process cartridge having a constitution as illustrated in FIG. 12. The process cartridge was set in an image forming apparatus, IMAGIO MF-2200 from Ricoh Company Limited which had been modified so as to have a laser diode emitting light having a wavelength of 780 nm serving as the image irradiator and a proximity roller charger having a constitution as illustrated in FIG. 10 in which a gap of 100 μm is formed between the photoreceptor and the charging member. A 100,000-sheet running test was performed for each process cartridge using a A-4 size plain paper which was fed through the image forming apparatus in its longitudinal direction.

With respect to evaluation of image qualities, background fouling and image density were graded into the following four ranks:

⊚: excellent

◯: good

Δ: fair

X: bad

In addition, the potential (VL) of a portion of the photoreceptor, which had been exposed to laser light of the laser diode in a full emission state, was measured with a surface 10 potential meter set in the vicinity of the image developer at the beginning and end of the running test. The charging conditions were as follows:

DC bias: −850 V

AC bias: 1.5 kV (peak to peak voltage)

2 kHz (frequency)

The results are shown in Table 2.

TABLE 2

| | | Ave. | | | | VL (−V) | |
|---|---|---|---|---|---|---|---|
| | Solvent | particle | Surface | Image qualities | | At the | At the |
| | of CTL | diameter | roughness | Background | Image | start of | end of |
| | liquid | (μm) | (μm) | fouling | density | test | test |
| Ex. 1 | THF | 0.2 | 1.0 | ◯ | ◯ | 90 | 95 |
| Ex. 2 | THF | 0.2 | 0.6 | ◯ | ◯ | 85 | 95 |
| Ex. 3 | THF | 0.2 | 0.3 | Δ | ◯ | 85 | 90 |
| Ex. 4 | THF | 0.2 | 0.4 | ◯ | ◯ | 95 | 105 |
| Ex. 5 | THF | 0.6 | 1.0 | Δ | ◯ | 100 | 125 |
| Ex. 6 | Dioxolan | 0.2 | 1.0 | ◯ | ◯ | 100 | 110 |
| Ex. 7 | THF/ | 0.2 | 1.0 | ◯ | ◯ | 80 | 85 |
| | toluene | | | | | | |
| Comp. | THF | 0.2 | — | X | X | 100 | 160 |
| Ex. 1 | | | | | | | |
| Comp. | THF | 0.6 | 0.6 | X | Δ | 110 | 150 |
| Ex. 2 | | | | | | | |
| Comp. | THF | 0.6 | 0.3 | X | X | 100 | 170 |
| Ex. 3 | | | | | | | |
| Comp. | THF | 0.6 | 0.4 | X | X | 115 | 165 |
| Ex. 4 | | | | | | | |
| Comp. | THF | 0.6 | — | X | X | 120 | 180 |
| Ex. 5 | | | | | | | |
| Comp. | Dioxolan | 0.2 | — | X | X | 130 | 200 |
| Ex. 6 | | | | | | | |
| Comp. | THF/ | 0.2 | — | X | X | 100 | 160 |
| Ex. 7 | Toluene | | | | | | |
| Ref. | Dichloromethane | 0.2 | 1.0 | Δ | ◯ | 85 | 90 |
| Ex. 1 | | | | | | | |
| Ref. | Chloroform | 0.2 | 1.0 | Δ | ◯ | 95 | 100 |
| Ex. 2 | | | | | | | |
| Ex. 8 | THF | 0.2 | 0.6 | Δ | Δ | 115 | 145 |
| Ex. 9 | THF | 0.2 | 0.6 | Δ | Δ | 105 | 135 |
| Ex. 10 | THF | 0.2 | 0.6 | Δ | Δ | 110 | 140 |
| Ex. 11 | THF | 0.2 | 0.6 | Δ | Δ | 105 | 140 |
| Ex. 12 | THF | 0.2 | 0.6 | Δ | Δ | 110 | 145 |
| Ex. 13 | THF | 0.2 | 0.6 | Δ | Δ | 105 | 135 |
| Ex. 14 | THF | 0.2 | 0.6 | ⊚ | ⊚ | 85 | 95 |
| Ex. 15 | THF | 0.2 | 0.6 | ⊚ | ◯ | 80 | 90 |
| Ex. 16 | THF | 0.2 | 1.0 | Δ | ◯ | 100 | 120 |
| Comp. | THF | 0.2 | 1.0 | X | Δ | 100 | 145 |
| Ex. 8 | | | | | | | |

As can be understood from Table 2, the photoreceptors of Examples 1 to 16, whose CGL is formed without using halogen-containing solvents, can maintain good photosensitivity even when used for a long period of time. Therefore, the photoreceptors can stably produce good images.

In addition, as can be understood from comparison of the photoreceptor of Example 2 with the photoreceptors of Examples 8 to 13, a TiOPc having a maximum peak at a Bragg (2θ) angle of 27.2°±0.2° and a lowest angle peak at 7.30°±0.2° without having a peak in an angle range of from 7.4° to 9.4° and at an angle of 26.3° is used, the resultant photoreceptor has relatively good properties compared to the photoreceptors using other TiOPc. In addition, when the CGL coating liquid is filtered with a filter having an effective pore diameter of 3 μm to remove large particles therein (Example 15) or a TiOPc synthesized so as to have a relatively small particle diameter is used (Example 14), the resultant photoreceptors have better properties than the photoreceptor of Example 2.

### Example 17

The procedure for preparation of the photoreceptor in Example 1 was repeated except that the CTL coating liquid was replaced with the following CTL coating liquid.

Formula of CTL Coating Liquid

| | |
|---|---|
| Charge transport polymer | 10 |
| having the following formula (13) | |
| 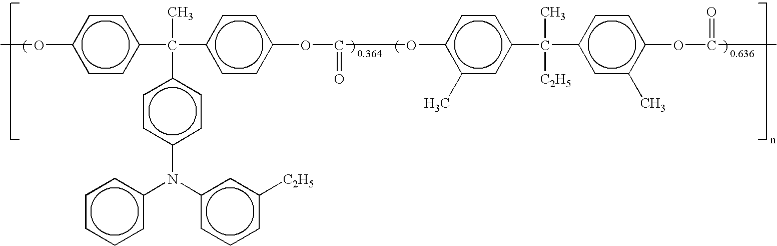 | (13) |
| Silicone oil | 0.001 |
| (KF-50 from Shin-Etsu Chemical Co., Ltd.) | 100 |
| Tetrahydrofuran | |

### Example 18

The procedure for preparation of the photoreceptor in Example 1 was repeated except that the following protective layer coating liquid was coated on the CTL and then dried for 20 minutes at 140° C. to prepare a protective layer having a thickness of 2 μm on the CTL layer.

Formula of Protective Layer Coating Liquid

| | |
|---|---|
| Polycarbonate resin | 3.8 |
| (IUPILON Z200 from Mitsubishi Gas Chemical Co., Inc.) | |
| CTM having formula (4) | 2.8 |
| Particulate α-alumina | 5.6 |
| (resistivity: 2.5 × 10¹² Ω · cm, average primary particle diameter: | |
| 0.5 μm) | |
| Cyclohexanone | 80 |
| Tetrahydrofuran | 280 |

### Example 19

The procedure for preparation of the photoreceptor in Example 18 was repeated except that the protective layer coating liquid was replaced with the following protective layer coating liquid.

Formula of Protective Layer Coating Liquid

| | |
|---|---|
| Polycarbonate resin | 3.8 |
| (IUPILON Z200 from Mitsubishi Gas Chemical Co., Inc.) | |
| CTM having formula (4) | 2.8 |
| Particulate silica | 2.6 |
| (resistivity: 4 × 10¹² Ω · cm, average primary particle diameter: | |
| 0.3 μm) | |
| Cyclohexanone | 80 |
| Tetrahydrofuran | 280 |

### Example 20

The procedure for preparation of the photoreceptor in Example 18 was repeated except that the protective layer coating liquid was replaced with the following protective layer coating liquid.

Formula of Protective Layer Coating Liquid

| | |
|---|---|
| Polycarbonate resin | 3.8 |
| (IUPILON Z200 from Mitsubishi Gas Chemical Co., Inc.) | |
| CTM having formula (4) | 2.8 |
| Particulate titanium oxide | 2.6 |
| (resistivity: 1.5 × 10¹⁰ Ω · cm, average primary particle diameter: | |
| 0.5 μm) | |
| Cyclohexanone | 80 |
| Tetrahydrofuran | 280 |

### Example 21

The procedure for preparation of the photoreceptor in Example 18 was repeated except that the protective layer coating liquid was replaced with the following protective layer coating liquid.

Formula of Protective Layer Coating Liquid

| | |
|---|---|
| Polycarbonate resin | 3.8 |
| (IUPILON Z200 from Mitsubishi Gas Chemical Co., Inc.) | |
| CTM having formula (4) | 2.8 |
| Tin oxide-antimony oxide powder | 2.6 |
| (resistivity: 1 × 10⁶ Ω · cm, average primary particle diameter: | |
| 0.4 μm) | |
| Cyclohexanone | 80 |
| Tetrahydrofuran | 280 |

### Example 22

The procedure for preparation of the photoreceptor in Example 18 was repeated except that the protective layer coating liquid was replaced with the following protective layer coating liquid.

Formula of Protective Layer Coating Liquid

| | |
|---|---|
| Charge transport polymer | 6.6 |
| having the following formula | |
| 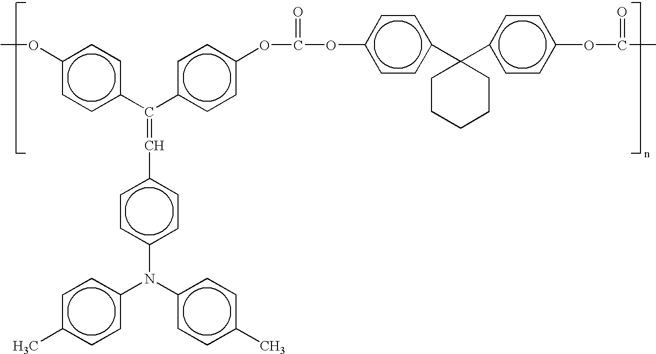 | |
| Particulate α-alumina | 2.6 |
| (resistivity: 2.5 ×10¹² Ω · cm, average primary particle | |
| diameter: 0.5 μm) | |
| Cyclohexanone | 120 |
| Tetrahydrofuran | 240 |

### Example 23

The procedure for preparation of the photoreceptor in Example 1 was repeated except that the aluminum cylinder (JIS1050) had been subjected to an anodizing treatment before forming the CGL and CTL.

Anodizing Treatment

The surface of the aluminum cylinder was subjected to a mirror finish treatment followed by a degreasing treatment and a water washing treatment. Then the aluminum cylinder was dipped into an electrolyte of 15 vol % solution of sulfuric acid at 20° C. and subjected to an anodizing treatment for 30 minutes while applying a voltage of 15 V. After being washed with water, the aluminum cylinder was subjected to a sealing treatment using a 7% aqueous solution of nickel acetate at 50° C. followed by washing with pure water. Thus, an anodic oxide film of 6 μm thick was formed on the surface of the aluminum cylinder substrate.

Evaluation

Each of the thus prepared photoreceptors of Examples 1 and 17 to 23 was set in a process cartridge having a constitution as illustrated in FIG. 12. The process cartridge was set in an image forming apparatus, IMAGIO MF-2200 from Ricoh Company Limited which had been modified so as to have a laser diode emitting light having a wavelength of 780 nm serving as the image irradiator and a proximity roller charger having a constitution as illustrated in FIG. 10 in which a gap of 100 μm is formed between the photoreceptor and the charging member. A 150,000-sheet running test was performed for each process cartridge using a A-4 size plain paper which was fed through the image forming apparatus in its longitudinal direction.

With respect to evaluation of image qualities, background fouling and image density were graded into the following four ranks:

○: excellent

◯: good

A: fair

X: bad

In addition, the abrasion amount of surface of the photoreceptor was measured after the running test.

Further, after the running test, half tone images constituted of one-dot images were produced to evaluate the dot reproducibility of the images.

The results are shown in Table 3.

TABLE 3

| | | Image qualities | | | Abrasion |
|---|---|---|---|---|---|
| | Protective | Background | Image | Dot | amount |
| | layer | fouling | density | reproducibility | (μm) |
| Ex. 1 | No | Δ | ◯ | good | 8.7 |
| Ex. 17 | No | ◯ | ◯ | good | 3.1 |
| Ex. 18 | Yes | ◯ | ◯ | good | 0.3 |
| Ex. 19 | Yes | ◯ | ◯ | good | 0.5 |
| Ex. 20 | Yes | ◯ | ◯ | good | 0.3 |
| Ex. 21 | Yes | ◯ | Δ | Slightly | 0.4 |
| | | | | blurred | |
| Ex. 22 | Yes | ⊚ | ◯ | good | 0.2 |
| Ex. 23 | No | ⊚ | ◯ | good | 8.6 |

As can be understood from Table 3, the photoreceptors of Examples 17 to 22 have excellent abrasion resistance. In addition, the photoreceptors can produce images without background fouling. The photoreceptors of Examples 22 and 23 can produce images having excellent background property. The photoreceptor of Example 21 has good abrasion resistance but the dot reproducibility is slightly inferior to the other photoreceptors after the running test.

### Example 24

The procedure for preparation and evaluation of the photoreceptor in Example 1 was repeated except that the gap between the charging member and the photoreceptor was changed from 100 μm to 50 μm.

### Example 25

The procedure for preparation and evaluation of the photoreceptor in Example 1 was repeated except that the gap between the charging member and the photoreceptor was changed from 100 μm to 180 μm.

### Example 26

The procedure for preparation and evaluation of the photoreceptor in Example 1 was repeated except that the gap between the charging member and the photoreceptor was changed from 100 μm to 250 μm.

### Example 27

The procedure for preparation and evaluation of the photoreceptor in Example 1 was repeated except that the charging conditions were changed to the following.

DC bias: −1580 V

AC bias: not applied

As a result of evaluation of the photoreceptors of Example 24 to 27, the properties thereof were almost the same as those of the photoreceptor of Example 1. However, when half tone images were produced after the 100,000-sheet running test, the images produced by the photoreceptors of Examples 1, 24 and 25 were good but the images produced by the photoreceptors of Examples 26 and 27 had slightly uneven image density due to uneven charging.

### Example 28

The procedure for preparation and evaluation of the photoreceptor in Example 18 was repeated except that the charger of the image forming apparatus used for evaluation of the photoreceptor was changed from the charging roller to a scorotron charger to perform a 150,000-sheet running test. In addition, after the running test, 50 images were produced under a condition of 30° C. and 90% RH.

As a result, the image qualities of the images produced by the photoreceptor of Example 28 were almost the same as those of the photoreceptor of Example 18, but the image forming apparatus seriously smelled ozone. In addition, the images produced by the photoreceptor of Example 28 under a condition of 30° C. and 90% RH were slightly blurred whereas the images produced by the photoreceptor of Example 18 were not blurred.

### Example 29

The photoreceptor prepared in the same way as performed in Example 2 was set in a full color image forming apparatus having a constitution as illustrated in FIG. 11 to perform a running test in which 100,000 full color images were produced under the below-mentioned conditions.

With respect to evaluation of image qualities, background fouling and image density were graded into the following four ranks:

⊚: excellent

◯: good

Δ: fair

X: bad

In addition, the potential (VL) of a portion of the photoreceptor, which had been exposed to laser light of the laser diode in a full emission state, was measured with a surface potential meter set in the vicinity of the image developer at the beginning and end of the running test. The recording conditions were as follows:

DC bias: −850 V

AC bias: 1.5 kV (peak to peak voltage)

2 kHz (frequency)

Charger: the charger same as that used for evaluating the photoreceptor of Example 2

Image irradiator: a laser diode emitting laser light having a wavelength of 780 nm (a polygon mirror was used)

### Comparative Example 9

The procedure for preparation and evaluation of the photoreceptor in Example 29 was repeated except that the CGL coating liquid was replaced with the CGL coating liquid used in Comparative Example 2.

The results are shown in Tables 4-1 and 4-2.

TABLE 4-1

| | | Average particle | Surface roughness of |
|---|---|---|---|
| | Solvent of CTL | diameter of | intermediate |
| | coating liquid | CGM (μm) | layer (μm) |
| Ex. 29 | THF | 0.2 | 0.6 |
| Comp. Ex. 9 | THF | 0.6 | 0.6 |

TABLE 4-2

| | | | | VL (−V) | |
|---|---|---|---|---|---|
| | | | | At the | |
| | Image qualities | | | start of | At the end |
| | Background | Image | Color | running | of running |
| | fouling | density | balance | test | test |
| Ex. 29 | ◯ | ◯ | ◯ | 90 | 100 |
| Comp. | X | Δ | X | 120 | 155 |
| Ex. 9 | | | | | |

Finally, an experiment was performed to confirmed whether the lowest angle peak of the X-ray diffraction spectrum of the TiOPc of the present invention, which is observed at an angle of 7.3° is the same as or different from the lowest angle peak of the X-ray diffraction spectrum of known TiOPcs, which is observed at an angle of 7.5°.

### Synthesis Example 9

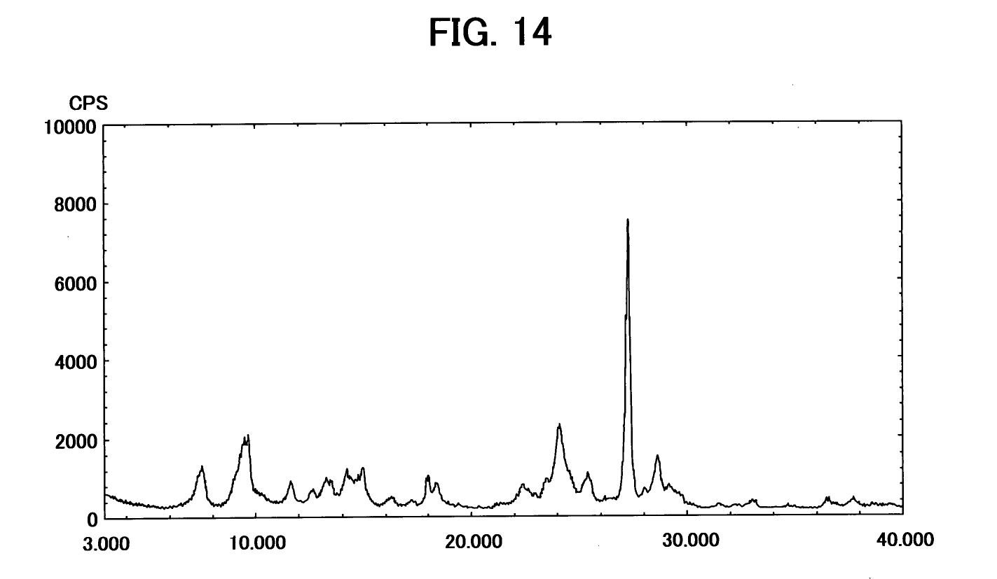

The procedure for preparation of the TiOPc in Synthesis Example 1 and the X-ray diffraction analysis was repeated except that the crystal conversion solvent was changed from methylene chloride to 2-butanone. The X-ray diffraction spectrum of the thus prepared TiOPc is illustrated in FIG. 14. As clearly understood from comparison of the X-ray diffraction spectrum of the TiOPc of the present invention as shown in FIG. 13 with that as shown in FIG. 14, the lowest angle peak (7.3°) of the TiOPc of the present invention is different from the lowest angle peak (7.5°) of the conventional TiOPc.

### Measurement Example 1

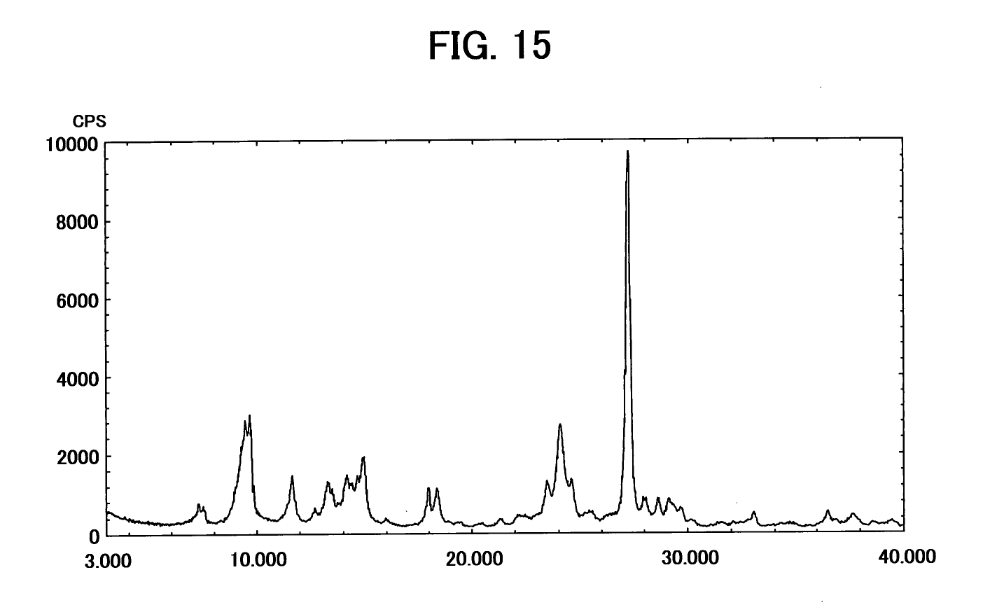

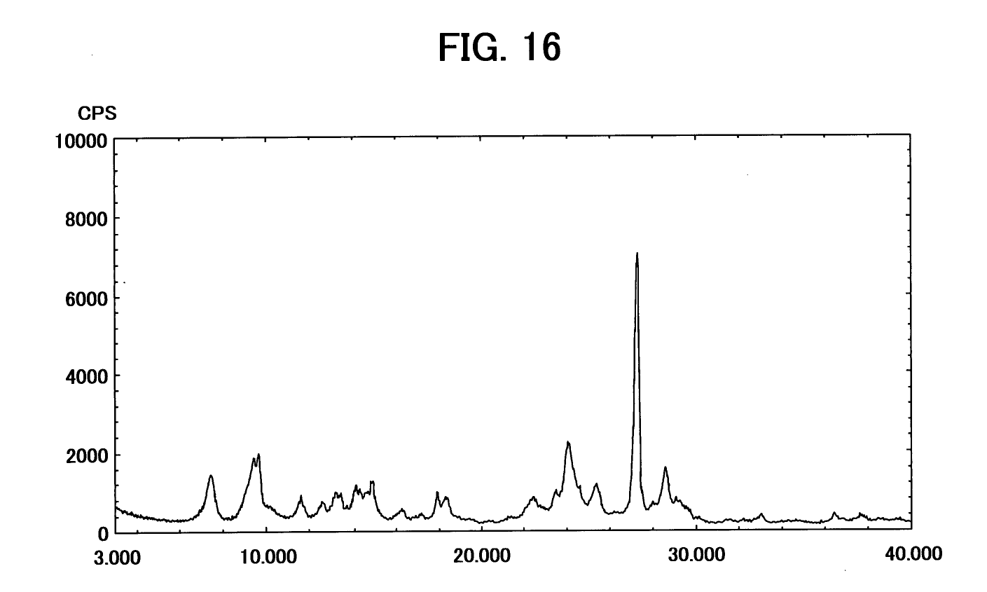

The TiOPc which was prepared in Synthesis Example 1 and which has a lowest angle peak at 7.3° was mixed with a TiOPc which was prepared by the same method as disclosed in published unexamined Japanese Patent Application No. 61-239248 and which has a lowest angle peak at 7.5°, in a weight ratio of 100:3. The mixture was mixed in a mortar. The mixture was subjected to the X-ray diffraction analysis. The spectrum of the mixture is shown in FIG. 15.

### Measurement Example 2

The TiOPc which was prepared in Synthesis Example 9 and which has a lowest angle peak at 7.5° was mixed with a TiOPc which was prepared by the same method as disclosed in published unexamined Japanese Patent Application No. 61-239248 and which has a lowest angle peak at 7.5°, in a weight ratio of 100:3. The mixture was mixed in a mortar. The mixture was subjected to the X-ray diffraction analysis. The spectrum of the mixture is shown in FIG. 16.

As can be understood from the spectrum as shown in FIG. 15, two independent peaks are present at 7.3° and 7.5°. Therefore, the peaks are different from the other. In contrast, in the spectrum as shown in FIG. 16, only a lowest angle peak is present at 7.5°, and therefore the spectrum is clearly different from the spectrum as shown in FIG. 15.

Effects of the Present Invention

As can be understood from the above description, a photoreceptor which has good photosensitivity and charging properties even when repeatedly used for a long period of time and which has a charge transport layer formed without using a halogen-containing solvent is provided. In addition, a method for manufacturing the photoreceptor, and an image forming apparatus and a process cartridge using the photoreceptor, which can produce high quality images for a long period of time, are also provided.

This document claims priority and contains subject matter related to Japanese Patent Applications Nos. 2002-191290, 2002-306757 and 2003-78695, filed on Jun. 28, 2002, Oct. 22, 2002, and March 20, 2003, respectively, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A photoreceptor comprising:
an electroconductive substrate;
a charge generation layer located overlying the electroconductive substrate optionally with an intermediate layer therebetween; and
a charge transport layer formed overlying the charge generation layer using a non-halogenated solvent and comprising a charge transport material and a resin,
wherein the charge generation layer comprises a polyvinyl acetal resin and a charge generation material having an average particle diameter less than a roughness of a surface of either the electroconductive substrate or the intermediate layer, on which the charge generation layer is located.

2. The photoreceptor according to claim 1, wherein the average particle diameter of the charge generation material is not greater than 0.3 μm and not greater than ⅔ of the roughness of the surface of either the electroconductive substrate or the intermediate layer.

3. The photoreceptor according to claim 1, wherein the charge generation material is a titanyl phthalocyanine.

4. The photoreceptor according to claim 3, wherein the titanyl phthalocyanine has an X-ray diffraction spectrum in which a maximum peak is observed at a Bragg (2θ) angle of 27.2°±0.2° when a Cu—Kα X-ray having a wavelength of 1.542 Å is used.

5. The photoreceptor according to claim 4, wherein the titanyl phthalocyanine further has a lowest angle peak at an angle of 7.3°±0.2°, and wherein an interval between the lowest angle peak to a next peak at a high angle side is not less than 2.0°.

6. The photoreceptor according to claim 5, wherein the titanyl phthalocyanine has no peak at an angle of 26.3°.

7. The photoreceptor according to claim 3, wherein the charge generation layer is formed by coating a coating liquid comprising a dispersion which is prepared by dispersing the titanyl phthalocyanine so as to have a particle diameter distribution such that an average particle diameter is not greater than 0.3 μm and a standard deviation is not greater than 0.2 μm and then filtering the dispersed titanyl phthalocyanine liquid with a filter having an effective pore size not greater than 3 μm.

8. The photoreceptor according to claim 3, wherein the titanyl phthalocyanine in the charge generation layer is prepared by subjecting a titanyl phthalocyanine which has either an irregular form or a low crystallinity and has a primary particle diameter not greater than 0.1 μm and which has an X-ray diffraction spectrum in which a maximum peak having a half width not less than 1° is observed at a Bragg (2θ) angle of from 7.0° to 7.5° (±0.2°) when a Cu—Kα X-ray having a wavelength of 1.542 Å is used, to a crystal conversion treatment using an organic solvent in the presence of water to form a crystal-changed titanyl phthalocyanine, and then subjecting the crystal-changed titanyl phthalocyanine to a filtering treatment before the crystal-changed titanyl phthalocyanine has an average primary particle diameter not less than 0.3 μm.

9. The photoreceptor according to claim 1, wherein the charge transport layer further comprises a polycarbonate resin having at least a triaryl amine structure in at least one of a main chain and a side chain.

10. The photoreceptor according to claim 1, further comprising:
a protective layer located overlying the charge transport layer.

11. The photoreceptor according to claim 10, wherein the protective layer comprises an inorganic pigment having a resistivity not less than 1×10¹⁰ Ω·cm.

12. The photoreceptor according to claim 11, wherein the inorganic pigment is a material selected from a group consisting of alumina, titanium oxide and silica.

13. The photoreceptor according to claim 12, wherein the inorganic pigment is α-alumina.

14. The photoreceptor according to claim 10, wherein the protective layer comprises a charge transport polymer.

15. The photoreceptor according to claim 1, wherein a surface of the electroconductive substrate is subjected to an anodic oxidation treatment.

16. The photoreceptor according to claim 1, wherein the non-halogenated solvent is a solvent selected from the group consisting of cyclic ethers and aromatic hydrocarbons.

17. An image forming apparatus comprising:
at least one image forming unit comprising:
an image bearing member;
a charger configured to charge the image bearing member;
a light irradiator configured to irradiate the image bearing member with light to form an electrostatic latent image on the image bearing member;
an image developer configured to develop the electrostatic latent image with a developer comprising a toner to form a toner image on the image bearing member; and
a transfer device configured to transfer the toner image onto a receiving material,
wherein the image bearing member is the photoreceptor of according to claim 1.

18. The image forming apparatus according to claim 17, comprising plural image forming units.

19. The image forming apparatus according to claim 17, wherein the light irradiator comprises at least one of a light emitting diode and a laser diode.

20. The image forming apparatus according to claim 17, wherein the charger is either a contact charger or a proximity charger which comprises a charging member charging the image bearing member while a gap is formed between the charging member and the image bearing member.

21. The image forming apparatus according to claim 20, the charger being a proximity charger, wherein the gap is not greater than 200 μm.

22. The image forming apparatus according to claim 20, wherein the charging member applies a DC voltage overlapped with an AC voltage.

23. A process cartridge comprising:
the photoreceptor according to claim 1; and
at least one of a charger configured to charge the photoreceptor, a light irradiator configured to irradiate the photoreceptor with light to form an electrostatic latent image on the photoreceptor, and an image developer configured to develop the electrostatic latent image with a developer comprising a toner to form a toner image on the photoreceptor.

24. A method for manufacturing a photoreceptor comprising:
preparing a charge generation layer coating liquid comprising a dispersion of a titanyl phthalocyanine having a particle diameter distribution such that an average particle diameter is not greater than 0.3 μm and a standard deviation is not greater than 0.2 μm and a polyvinyl acetal;
filtering the charge generation layer coating liquid with a filer having an effective pore size not greater than 3 μm;
coating the charge generation layer coating liquid overlying an electroconductive substrate optionally with an intermediate layer therebetween to form a charge generation layer thereon; and
coating a charge transport layer coating liquid comprising a charge transport material, a resin and a non-halogenated solvent on the charge generation layer to form a charge transport layer thereon,
wherein the charge generation material has an average particle diameter less than a roughness of a surface of either the electroconductive substrate or the intermediate layer, on which the charge generation layer is located.

25. The method according to claim 24, wherein the charge generation layer coating liquid preparing step comprises:
subjecting a titanyl phthalocyanine which has either an irregular form or a low crystallinity and has a primary particle diameter not greater than 0.1 μm and which has an X-ray diffraction spectrum in which a maximum peak having a half width not less than 10 is observed at a Bragg (2θ) angle of from 7.0° to 7.5° (±0.2°) when a Cu—Kα X-ray having a wavelength of 1.542 Å is used, to a crystal conversion treatment using an organic solvent in the presence of water to form a crystal-changed titanyl phthalocyanine;
then subjecting the crystal-changed titanyl phthalocyanine to a filtering treatment before the crystal-changed titanyl phthalocyanine has an average primary particle diameter not less than 0.3 μm; and
preparing a charge generation layer coating liquid comprising the crystal-changed titanyl phthalocyanine having a particle diameter distribution such that an average particle diameter is not greater than 0.3 μm and a standard deviation is not greater than 0.2 μm and a polyvinyl acetal.

26. The method according to claim 24, wherein the non-halogenated solvent is a solvent selected from the group consisting of cyclic ethers and aromatic hydrocarbons.
